(19) United States
(12) Patent Application Publication
(10) Pub. No.: US 2026/0129654 A1
(43) Pub. Date: May 7, 2026

(54) COORDINATION OF A DOWNLINK INTERRUPTION ASSOCIATED WITH AN UPLINK TRANSMISSION SWITCH FROM A FREQUENCY DIVISION DUPLEXING CARRIER TO A TIME DIVISION DUPLEXING CARRIER

(71) Applicant: QUALCOMM Incorporated, San Diego, CA (US)

(72) Inventors: Morteza BANAGAR, San Diego, CA (US); Jianming ZHU, Acton, MA (US); Enoch Shiao-Kuang LU, San Diego, CA (US); Samirbhai MACWAN, San Diego, CA (US); Tarandeep VIRK, San Diego, CA (US); Marc AZAR, La Jolla, CA (US); Tae Sun KIM, San Diego, CA (US); Mihir NABAR, Hyderabad (IN); Lai Suen WAN, San Diego, CA (US); Pranay Sudeep RUNGTA, New York, NY (US)

(21) Appl. No.: 19/436,274

(22) Filed: Dec. 30, 2025

Related U.S. Application Data
(63) Continuation of application No. 18/937,741, filed on Nov. 5, 2024.

(51) Int. Cl. H04W 72/231; H04L 5/14; H04W 72/21; H04W 72/566

(52) U.S. Cl. CPC H04W 72/231; H04L 5/14; H04W 72/21; H04W 72/566

(57) ABSTRACT

Methods, systems, and devices for wireless communication are described. Various aspects relate to signaling mechanisms according to which a user equipment (UE) and a network entity may coordinate on interruptions of downlink signaling, including interruptions associated with a temporary switch, at the UE, from a first carrier associated with a frequency division duplexing (FDD) communication scheme to a second carrier associated with a time division duplexing (TDD) communication scheme. In some examples, the UE may transmit, to the network entity, control signaling that includes an information element. The information element may include a first indication of an interruption of downlink signaling via the first carrier and a second indication of a duration of the interruption. In accordance with providing the first and second indications to the network entity, the UE may transmit uplink signaling via the second carrier within the duration of the interruption.

### CROSS REFERENCE

The present Application for Patent is a continuation of U.S. patent application Ser. No. 18/937,741 by BANAGAR et al., entitled “COORDINATION OF A DOWNLINK INTERRUPTION ASSOCIATED WITH AN UPLINK TRANSMISSION SWITCH FROM A FREQUENCY DIVISION DUPLEXING CARRIER TO A TIME DIVISION DUPLEXING CARRIER,” filed Nov. 5, 2024, assigned to the assignee hereof, and expressly incorporated by reference in its entirety herein.

### TECHNICAL FIELD

The following relates to wireless communication, including coordination of a downlink interruption associated with an uplink transmission switch from a frequency division duplexing (FDD) carrier to a time division duplexing (TDD) carrier.

### DESCRIPTION OF THE RELATED TECHNOLOGY

Wireless communication systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

In some wireless communication systems, a UE may perform communication in accordance with a time division duplexing (TDD) communication scheme and/or a frequency division duplexing (FDD) communication scheme. In accordance with a TDD communication scheme, a UE (or any other wireless communication device capable of TDD) may use multiple time slots to separate transmission and reception via a same frequency (such as a same frequency band or channel). In accordance with an FDD communication scheme, a UE (or any other wireless communication device capable of FDD) may use different frequencies (such as different frequency bands or channels) to separate transmission and reception occurring simultaneously. In some systems, a UE may additionally support carrier aggregation, according to which the UE may communicate with a base station using multiple carriers. In some of such systems, the UE communicate in accordance with different communication schemes via different carriers. For example, the UE may communicate in accordance with an FDD communication scheme using a first carrier and may communicate in accordance with a TDD communication scheme using a second carrier.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a user equipment (UE). The UE may include a processing system that includes processor circuitry and memory circuitry that stores code. The processing system may be configured to cause the UE to transmit control signaling that includes an information element to a network entity, the information element including a first indication of an interruption of downlink signaling from the network entity to the UE via a first carrier associated with a frequency division duplexing (FDD) communication scheme and including a second indication of a duration of the interruption of the downlink signaling, the duration of the interruption of the downlink signaling associated with a temporary switch, at the UE, from the first carrier associated with the FDD communication scheme to a second carrier associated with a time division duplexing (TDD) communication scheme, and transmit uplink signaling to the network entity via the second carrier associated with the TDD communication scheme within the duration of the interruption of the downlink signaling.

Another innovative aspect of the subject matter described in this disclosure can be implemented in a method for wireless communication by or at a UE. The method may include transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme, and transmitting uplink signaling to the network entity via the second carrier associated with the TDD communication scheme within the duration of the interruption of the downlink signaling.

Another innovative aspect of the subject matter described in this disclosure can be implemented in a UE. The UE may include means for transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme, and means for transmitting uplink signaling to the network entity via the second carrier associated with the TDD communication scheme within the duration of the interruption of the downlink signaling.

Another innovative aspect of the subject matter described in this disclosure can be implemented in a non-transitory computer-readable medium storing code for wireless communication by a UE. The code may include instructions executable by one or more processors (such as a processing system) to transmit control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme, and transmit uplink signaling to the network entity via the second carrier associated with the TDD communication scheme within the duration of the interruption of the downlink signaling.

Some implementations of the method, UEs, and non-transitory computer-readable medium described herein may further include operations, features, means, or instructions for establishing, in accordance with a carrier aggregation at the UE, a set of multiple carriers associated with communication between the UE and the network entity, the set of multiple carriers including the first carrier associated with the FDD communication scheme and the second carrier associated with the TDD communication scheme.

Some implementations of the method, UEs, and non-transitory computer-readable medium described herein may further include operations, features, means, or instructions for receiving, from the network entity, a first command that indicates the UE to switch, at a first time, from the first carrier associated with the FDD communication scheme to the second carrier associated with the TDD communication scheme and receiving, from the network entity, a second command that indicates the UE to switch, at a second time, from the second carrier associated with the TDD communication scheme to the first carrier associated with the FDD communication scheme, where the duration of the interruption of the downlink signaling spans between the first time and the second time.

Some implementations of the method, UEs, and non-transitory computer-readable medium described herein may further include operations, features, means, or instructions for receiving, from the network entity, a command that indicates the UE to switch, at a first time, from the first carrier associated with the FDD communication scheme to the second carrier associated with the TDD communication scheme, where the duration of the interruption of the downlink signaling spans from the first time.

In some implementations of the method, UEs, and non-transitory computer-readable medium described herein, the UE includes a set of multiple transmit chains, the set of multiple transmit chains includes a first transmit chain initially associated with the first carrier associated with the FDD communication scheme and a second transmit chain initially associated with the second carrier associated with the TDD communication scheme, and the UE switches the first transmit chain from the first carrier associated with the FDD communication scheme to the second carrier associated with the TDD communication scheme in accordance with the temporary switch from the first carrier associated with the FDD communication scheme to the second carrier associated with the TDD communication scheme and transmits the uplink signaling using at least the first transmit chain.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communication system that supports coordination of a downlink interruption associated with an uplink transmission switch from a frequency division duplexing (FDD) carrier to a time division duplexing (TDD) carrier in accordance with one or more aspects of the present disclosure.

FIGS. 2 and 3 show example transmit and/or receive (Tx/Rx) paths at radio frequency front ends (RFFEs) that support coordination of a downlink interruption associated with an uplink transmission switch from an FDD carrier to a TDD carrier in accordance with one or more aspects of the present disclosure.

FIG. 4 shows example network signaling that supports coordination of a downlink interruption associated with an uplink transmission switch from an FDD carrier to a TDD carrier in accordance with one or more aspects of the present disclosure.

FIG. 5 shows an example communication timeline that supports coordination of a downlink interruption associated with an uplink transmission switch from an FDD carrier to a TDD carrier in accordance with one or more aspects of the present disclosure.

FIG. 6 shows an example signal path grouping that supports coordination of a downlink interruption associated with an uplink transmission switch from an FDD carrier to a TDD carrier in accordance with one or more aspects of the present disclosure.

FIG. 7 shows an example process flow that supports coordination of a downlink interruption associated with an uplink transmission switch from an FDD carrier to a TDD carrier in accordance with one or more aspects of the present disclosure.

FIGS. 8 and 9 show block diagrams of devices that support coordination of a downlink interruption associated with an uplink transmission switch from an FDD carrier to a TDD carrier in accordance with one or more aspects of the present disclosure.

FIG. 10 shows a block diagram of a communications manager that supports coordination of a downlink interruption associated with an uplink transmission switch from an FDD carrier to a TDD carrier in accordance with one or more aspects of the present disclosure.

FIG. 11 shows a diagram of a system including a device that supports coordination of a downlink interruption associated with an uplink transmission switch from an FDD carrier to a TDD carrier in accordance with one or more aspects of the present disclosure.

FIGS. 12-15 show flowcharts illustrating methods that support coordination of a downlink interruption associated with an uplink transmission switch from an FDD carrier to a TDD carrier in accordance with one or more aspects of the present disclosure.

Like reference numbers and designations in the various drawings indicate like elements.

### DETAILED DESCRIPTION

In some wireless communication systems, a user equipment (UE) may perform communication in accordance with one or more of various communication schemes, such as a time division duplexing (TDD) communication scheme and/or a frequency division duplexing (FDD) communication scheme. In accordance with a TDD communication scheme, the UE may use a first radio frequency (RF) chain to receive signaling via one or more antennas of the UE at a first time and may use the first RF chain or a second RF chain to transmit signaling via one or more antennas of the UE at a second time. To use different RF chains and/or different antennas at different times, the UE may (re)program an RF front end (RFFE) of the UE. In accordance with an FDD communication scheme, the UE may use a first RF chain to transmit and/or receive signaling at a first frequency via one or more first antennas of the UE and may use a second RF chain to transmit and/or receive signaling at a second frequency via one or more second antennas of the UE. In scenarios in which the UE supports carrier aggregation, and in which the UE communicates in accordance with an FDD communication scheme using a first carrier and a TDD communication scheme using a second carrier, the UE may toggle an RF switch (a switch in signal path(s) between one or more RF chains and one or more antennas) between uplink and downlink for the second carrier (the TDD carrier). In some RFFE configurations, such an RF switch may result in the UE being unable to receive signaling via the first carrier (the FDD carrier) for a duration of the RF switch. For example, the UE may initially use a first RF chain for FDD reception via a first antenna and, in scenarios in which the UE toggles an RF switch to use the first RF chain and/or the first antenna for a TDD transmission (such that the UE may switch the first RF chain and/or the first antenna from the first carrier to the second carrier), the FDD reception via the first RF chain may be interrupted. Such an interruption of the FDD reception may cause the UE to miss downlink signaling, which may adversely impact communication reliability at the UE.

Various aspects relate generally to one or more configurational-and/or signaling-based mechanisms according to which the UE may avoid and/or coordinate with a network entity regarding such interruptions of downlink signaling. Some aspects more specifically relate to mechanisms according to which the UE may transmit, to the network entity, a first indication of an interruption of downlink signaling from the network entity via the first carrier (the FDD carrier) and a second indication of a duration of the interruption. In some examples, the interruption of the downlink signaling may be associated with (such as based on, due to, or caused by) a temporary switch, at the UE, from the first carrier (the FDD carrier) to the second carrier (the TDD carrier). Such a temporary switch may be associated with (such as involve) a temporary switch of an RF chain and/or an antenna of the UE from the first carrier to the second carrier. The UE may transmit the first and second indications via control signaling, such as radio resource control (RRC) signaling. In some aspects, the UE may transmit the first and second indications via an information element included within or otherwise carried by the control signaling. In accordance with providing the first and second indications to the network entity, the UE may transmit uplink signaling via the second carrier within the duration of the interruption. Additionally, in some implementations, the UE may expect the network entity to refrain from transmitting downlink signaling intended for the UE within the duration of the interruption.

Particular aspects of the subject matter described in this disclosure can be implemented to realize one or more of the following potential advantages. In some examples, by transmitting the first and second indications to the network entity, the UE may coordinate with the network entity regarding an anticipated, expected, scheduled, or planned interruption of downlink signaling due to the temporary switch from the first carrier (the FDD carrier) to the second carrier (the TDD carrier). In accordance with such coordination between the UE and the network entity, the UE and the network entity may experience greater synchronization by enabling the network entity to buffer downlink signaling intended for the UE (until, for example, after the interruption, such as until after the UE has switched back to the first carrier), which may enable the UE to avoid missing downlink signaling due to the temporary switch and facilitate greater communication reliability. Further, by reducing the likelihood of the UE missing downlink signaling and by achieving greater communication reliability, the UE and the network entity may experience and/or support higher data rates, greater system capacity, and greater spectral efficiency, among other benefits, in accordance with the coordination between the UE and the network entity regarding the temporary switch between carriers at the UE.

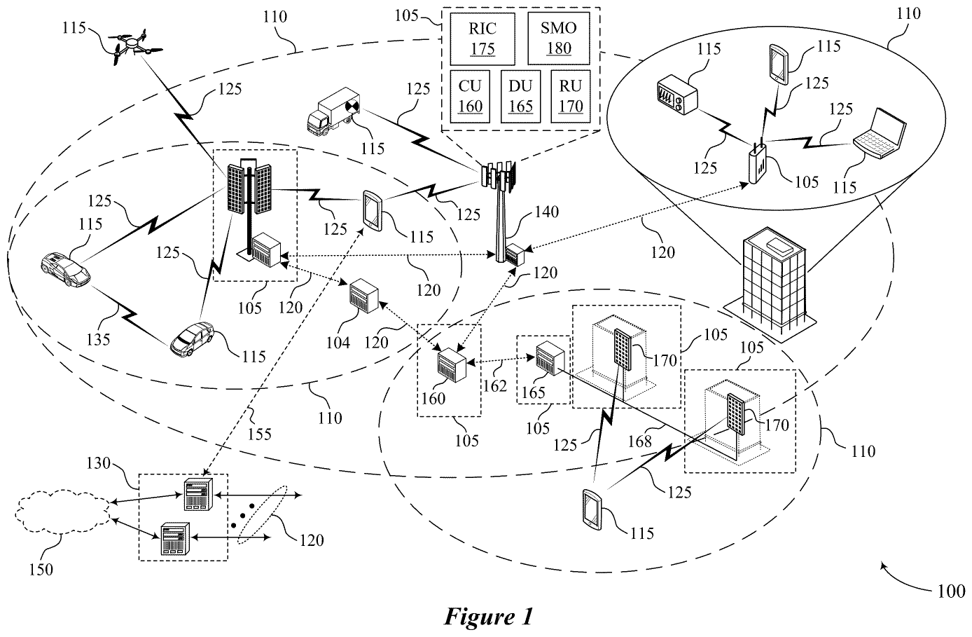

FIG. 1 shows an example of a wireless communication system 100 that supports coordination of a downlink interruption associated with an uplink transmission switch from an FDD carrier to a TDD carrier in accordance with one or more aspects of the present disclosure. The wireless communication system 100 may include one or more devices, such as one or more network devices (such as network entities 105), one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (such as a radio frequency (RF) access link). For example, a network entity 105 may support a coverage area 110 (such as a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communication system 100 (such as other wireless communication devices, including UEs 115 or network entities 105), as shown in FIG. 1.

A node of the wireless communication system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (such as in accordance with an S1, N2, N3, or other interface protocol). In some examples, network entities 105 may communicate with one another via backhaul communication link(s) 120 (such as in accordance with an X2, Xn, or other interface protocol) either directly (such as directly between network entities 105) or indirectly (such as via the core network 130). In some examples, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication link(s) 120, midhaul communication links 162, or fronthaul communication links 168 may be or include one or more wired links (such as an electrical link, an optical fiber link) or one or more wireless links (such as a radio link, a wireless optical link), among other examples or various combinations thereof. A UE 115 may communicate with the core network 130 via a communication link 155.

One or more of the network entities 105 or network equipment described herein may include or may be referred to as a base station 140 (such as a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (such as a base station 140) may be implemented in an aggregated (such as monolithic, standalone) base station architecture, which may be configured to utilize a protocol stack that is physically or logically integrated within one network entity (such as a network entity 105 or a single RAN node, such as a base station 140).

In some examples, a network entity 105 may be implemented in a disaggregated architecture (such as a disaggregated base station architecture, a disaggregated RAN architecture), which may be configured to utilize a protocol stack that is physically or logically distributed among multiple network entities (such as network entities 105), such as an integrated access and backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (such as a Near-Real Time RIC (Near-RT RIC), a Non-Real Time RIC (Non-RT RIC)), a Service Management and Orchestration (SMO) system, such as an SMO system 180, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some examples, one or more of the network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (such as layer 3 (L3 ), layer 2 (L2)) functionality and signaling (such as RRC, service data adaptation protocol (SDAP), Packet Data Convergence Protocol (PDCP)). The CU 160 (such as one or more CUs) may be connected to a DU 165 (such as one or more DUs) or an RU 170 (such as one or more RUs), or some combination thereof, and the DUs 165, RUs 170, or both may host lower protocol layers, such as layer 1 (L1 ) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or multiple different RUs, such as an RU 170). In some examples, a functional split between a CU 160 and a DU 165 or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (such as F1, F1-c, F1-u), and a DU 165 may be connected to an RU 170 via a fronthaul communication link 168 (such as open fronthaul (FH) interface). In some examples, a midhaul communication link 162 or a fronthaul communication link 168 may be implemented in accordance with an interface (such as a channel) between layers of a protocol stack supported by respective network entities (such as one or more of the network entities 105) that are in communication via such communication links.

In some wireless communication systems (such as the wireless communication system 100), infrastructure and spectral resources for radio access may support wireless backhaul link capabilities to supplement wired backhaul connections, providing an IAB network architecture (such as to a core network 130). In some examples, in an IAB network, one or more of the network entities 105 (such as network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (such as IAB donors) may be in communication with one or more additional devices (such as IAB node(s) 104) via supported access and backhaul links (such as backhaul communication link(s) 120). IAB node(s) 104 may include an IAB mobile termination (IAB-MT) controlled (such as scheduled) by one or more DUs (such as DUs 165) of a coupled IAB donor. An IAB-MT may be equipped with an independent set of antennas for relay of communications with UEs 115 or may share the same antennas (such as of an RU 170) of IAB node(s) 104 used for access via the DU 165 of the IAB node(s) 104 (such as referred to as virtual IAB-MT (vIAB-MT)). In some examples, the IAB node(s) 104 may include one or more DUs (such as DUs 165) that support communication links with additional entities (such as IAB node(s) 104, UEs 115) within the relay chain or configuration of the access network (such as downstream). In such examples, one or more components of the disaggregated RAN architecture (such as the IAB node(s) 104 or components of the IAB node(s) 104) may be configured to operate according to the techniques described herein.

In examples in which aspects are applied in the context of a disaggregated RAN architecture, one or more components of the disaggregated RAN architecture may be configured to support coordination of a downlink interruption associated with an uplink transmission switch from an FDD carrier to a TDD carrier. For example, some operations described as being performed by a UE 115 or a network entity 105 (such as a base station 140) may additionally, or alternatively, be performed by one or more components of the disaggregated RAN architecture (such as components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology. The “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (such as one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (such as a bandwidth part (BWP)) that is operated according to one or more PHY layer channels for a given RAT (such as LTE, LTE-A, LTE-A Pro, NR). Each PHY layer channel may carry acquisition signaling (such as synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a base station 140, a CU 160, a DU 165, a RU 170) of a RAN communicating with another device (such as directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be identified according to a channel raster for discovery by the UEs 115. A carrier may be operated in a standalone mode, in which initial acquisition and connection may be conducted by the UEs 115 via the carrier, or the carrier may be operated in a non-standalone mode, in which a connection is anchored using a different carrier (such as of the same or a different RAT).

The communication link(s) 125 of the wireless communication system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communications (such as in an FDD mode) or may be configured to carry downlink and uplink communications (such as in a TDD mode).

A carrier may be associated with a particular bandwidth of the RF spectrum and, in some examples, the carrier bandwidth may be referred to as a “system bandwidth” of the carrier or the wireless communication system 100. For example, the carrier bandwidth may be one of a set of bandwidths for carriers of a particular RAT (such as 1.4, 3, 5, 10, 15, 20, 40, or 80 megahertz (MHz)). Devices of the wireless communication system 100 (such as the network entities 105, the UEs 115, or both) may have hardware configurations that support communications using a particular carrier bandwidth or may be configurable to support communications using one of a set of carrier bandwidths. In some examples, the wireless communication system 100 may include network entities 105 or UEs 115 that support concurrent communications using carriers associated with multiple carrier bandwidths. In some examples, each served UE 115 may be configured for operating using portions (such as a sub-band, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively-numbered subframes or slots, and each subframe or slot may have the same duration. In some examples, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communication systems, such as the wireless communication system 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communication system 100 and may be referred to as a transmission time interval (TTI). In some examples, the TTI duration (such as a quantity of symbol periods in a TTI) may be variable. Additionally, or alternatively, the smallest scheduling unit of the wireless communication system 100 may be dynamically selected (such as in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to UEs 115 (such as one or more UEs) or may include UE-specific search space sets for sending control information to a UE 115 (such as a specific UE).

In some examples, a network entity 105 (such as a base station 140, an RU 170) may be movable and therefore provide communication coverage for a moving coverage area, such as the coverage area 110. In some examples, coverage areas 110 (such as different coverage areas) associated with different technologies may overlap, but the coverage areas 110 (such as different coverage areas) may be supported by the same network entity (such as a network entity 105). In some other examples, overlapping coverage areas, such as a coverage area 110, associated with different technologies may be supported by different network entities (such as the network entities 105). The wireless communication system 100 may include, for example, a heterogeneous network in which different types of the network entities 105 support communications for coverage areas 110 (such as different coverage areas) using the same or different RATs.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (such as one or more of the UEs 115) via a device-to-device (D2D) communication link, such as a D2D communication link 135 (such as in accordance with a peer-to-peer (P2P), D2D, or sidelink protocol). In some examples, one or more UEs 115 of a group that are performing D2D communications may be within the coverage area 110 of a network entity 105 (such as a base station 140, an RU 170), which may support aspects of such D2D communications being configured by (such as scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as base stations 140) associated with the core network 130. User IP packets may be transferred—the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (such as less than one hundred kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

In some wireless communication systems, such as the wireless communication system 100, a UE 115 (or any other wireless communication device, such as a network entity 105) may perform communication in accordance with one or more of various communication schemes, such as a TDD communication scheme and/or an FDD communication scheme. In some examples, a UE 115 (or any other wireless communication device capable of TDD and/or FDD) may use one or more RF chains of the UE 115 in accordance with the one or more communication schemes supported or used by the UE 115. For example, a UE 115 may support (such as operate, configure, or use) one or more RF chains and the UE 115 may communicate (such as transmit and/or receive) using the RF chain(s) depending on the communication scheme(s) supported or used by the UE 115. An RF chain, which may be located in or otherwise associated with an RFFE of a wireless communication device, may be a series of interconnected (such as electronically or communicatively coupled) electronic components that receive and/or transmit signals, that prepare signals for transmission (via one or more antennas), and/or that process received signals (obtained via one or more antennas). Such components may include one or more amplifiers, one or more filters, one or more mixers, one or more attenuators, one or more detectors, one or more switches, one or more synthesizers, one or more analog-to-digital converters (ADCs), and/or one or more digital-to-analog converters (DACs), among other example components associated with transmission and/or reception of wireless signaling. An RF chain may be or function as a transmit (Tx) chain, a receive (Rx) chain, or a transmit and/or receive (Tx/Rx) chain. A Tx/Rx chain may be equivalently referred to as a “TRx” chain.

In accordance with a TDD communication scheme, a UE 115 (or any other wireless communication device capable of TDD) may use multiple time slots to separate transmission and reception via a same frequency (such as a same frequency band or channel). For example, the UE 115 may use a first RF chain to receive signaling via one or more antennas of the UE 115 at a first time and may use the first RF chain or a second RF chain to transmit signaling via one or more antennas of the UE 115 at a second time. To use different RF chains and/or different antennas at different times for TDD communication, an action which the UE 115 may autonomously decide or select to perform, the UE 115 may reprogram an RFFE of the UE 115. In other words, as part of TDD operation, a UE 115 may change the signal paths between one or more antennas and one or more RF chains over time (such as in accordance with radio or channel conditions, among other examples). An RF chain that is associated with or otherwise used by the UE 115 for TDD communication may be referred to as a TDD RF chain (such as a TDD Tx chain, a TDD Rx chain, or a TDD TRx chain).

In accordance with an FDD communication scheme, a UE 115 (or any other wireless communication device capable of FDD) may use different frequencies (such as different frequency bands or channels) to separate transmission and reception occurring simultaneously. For example, the UE 115 may use a first RF chain to transmit and/or receive signaling at a first frequency via one or more first antennas of the UE 115 and may use a second RF chain to transmit and/or receive signaling at a second frequency via one or more second antennas of the UE 115. An RF chain that is associated with or otherwise used by the UE 115 for FDD communication may be referred to as an FDD RF chain (such as an FDD Tx chain, an FDD Rx chain, or an FDD TRx chain).

In examples in which a UE 115 supports both an FDD communication scheme and a TDD communication scheme, the UE 115 may use a first set of (one or more) RF chains for FDD communication and a second set of (one or more) RF chains for TDD communication. The first set of RF chains and the second set of RF chains may be different sets of RF chains, partially overlapping sets of RF chains, or the same set of RF chains. Further, in some examples, the UE 115 may support carrier aggregation and may communicate via different carriers using different communication schemes. For example, the UE 115 may communicate in accordance with an FDD communication scheme via a first carrier and may communicate in accordance with a TDD communication scheme via a second carrier.

In such examples, and in scenarios in which the UE 115 toggles an RF switch (a switch in the signal path(s) between one or more RF chains and one or more antennas) between uplink and downlink for the second carrier (the TDD carrier), the UE 115 may sometimes be unable to receive signaling via at least one RF chain for a duration of the RF switch. For example, the UE 115 may initially use a first RF chain for FDD reception via a first antenna and, in scenarios in which the UE 115 toggles an RF switch to use the first RF chain and/or the first antenna for TDD transmission (such that the UE 115 may switch the first RF chain and/or the first antenna from the first carrier to the second carrier for the TDD transmission), the FDD reception via the first RF chain and/or the first antenna may be interrupted. Such an interruption of the FDD reception may cause the UE 115 to miss downlink signaling, which may adversely impact communication reliability at the UE 115.

To coordinate with a network entity 105 (or any other wireless communication device with which the UE 115 communicates) regarding such an interruption, the UE 115 may transmit, to the network entity 105, a first indication of an interruption of downlink signaling from the network entity 105 via the first carrier (the FDD carrier) and a second indication of a duration of the interruption. In some implementations, the UE 115 may transmit the first and second indications via control signaling, such as RRC signaling. For example, the control signaling may be or include UE-assistance signaling (such as UE-assistance RRC signaling). In some implementations, the UE 115 may transmit the first and second indications via an information element included within or otherwise carried by the control signaling. For example, the UE 115 may provide the first indication of the interruption and the second indication of the duration of the interruption via a same (single) information element. In some other implementations, the UE 115 may provide the first indication of the interruption and the second indication of the duration of the interruption via different (multiple) information elements.

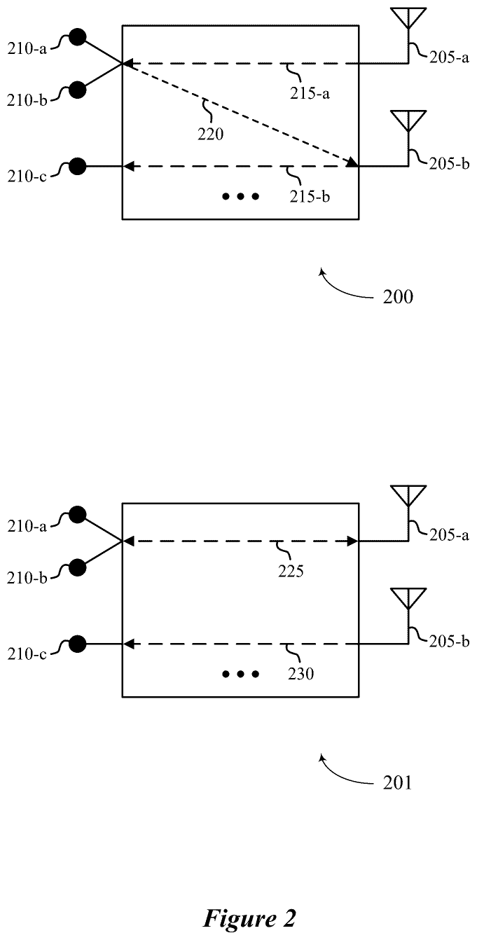

FIG. 2 shows example Tx/Rx paths at RFFEs 200 and 201 that support coordination of a downlink interruption associated with an uplink transmission switch from an FDD carrier to a TDD carrier in accordance with one or more aspects of the present disclosure. The RFFEs 200 and 201 may implement or be implemented to realize or facilitate one or more aspects of the wireless communication system 100. For example, a UE 115 (or any other wireless communication device illustrated by or described with reference to FIG. 1) may support (such as use, operate, or configure) the RFFE 200 and/or the RFFE 201.

The RFFEs 200 and 201 may each include a set of antennas, a set of RF chains, and Tx/Rx paths (such as signal paths) between the set of antennas and the set of RF chains. As illustrated in the example of FIG. 2, the set of antennas may include an antenna 205-a and an antenna 205-b, although a wireless communication device may operate any quantity of antennas without exceeding the scope of the present disclosure. As also illustrated in the example of FIG. 2, the set of RF chains may include an RF chain 210-a, an RF chain 210-b, and an RF chain 210-c, although a wireless communication device may operate any quantity of RF chains without exceeding the scope of the present disclosure. The RF chain 210-a may be representative of a TDD TRx0 (a first TDD TRx chain) and/or an FDD Rx0 (a first FDD Rx chain). The RF chain 210-b may be representative of an FDD TRx0 (a first FDD TRx chain) and/or a TDD Rx0 (a first TDD Rx chain). The RF chain 210-c may be representative of a TDD Rx1 (a second TDD Rx chain) and/or an FDD Rx1 (a second FDD Rx chain).

The RFFE 200 illustrates an example scenario of a cross switch between the set of antennas and the set of RF chains in a TDD communication scheme (such as in a TDD mode). In the TDD communication scheme, the network (a UE 115 and/or a network entity 105) may not expect uplink and downlink to occur together (such as simultaneously). In other words, in the TDD communication scheme, a hardware (of a UE 115) may support reception (via a signal path 215-a and/or a signal path 215-b) or transmission (via a signal path 220), but not both at the same time. In accordance with the TDD communication scheme, a UE 115 may connect an RFFE switch in different manners and, in at least some device types, a TDD Tx chain may connect to any antenna. For example, the UE 115 may use the signal path 220 to the antenna 205-b to perform an uplink transmission, with the use of the signal path 220 disrupting (such as interrupting, conflicting with, or canceling) downlink reception on the TDD Rx0 (via the signal path 215-a) and the TDD Rx1 (via the signal path 215-b) on the antenna 205-a and the antenna 205-b, respectively. By way of further example, the UE 115 may use the signal path 215-a and the signal path 215-b to the antenna 205-a and the antenna 205-b, respectively, to perform a downlink reception, with the use of the signal path 215-a and the signal path 215-b disrupting uplink transmission via the signal path 220.

The RFFE 201 illustrates an example scenario of a cross switch between the set of antennas and the set of RF chains in an FDD communication scheme (such as in an FDD mode). In the FDD communication mode, the network (a UE 115 and/or a network entity 105) may expect both uplink and downlink to be able to occur together (such as simultaneously). In other words, in the FDD communication scheme, a hardware (of a UE 115) may support concurrent uplink transmission and downlink reception. In accordance with the FDD communication mode, a UE 115 may refrain from reprogramming an RFFE switch during uplink and/or downlink slots. In the example of the RFFE 201, the UE 115 may transmit and/or receive signaling via a signal path 225 using the antenna 205-a and may receive signaling via a signal path 230 using the antenna 205-b.

In some example implementations of the present disclosure, a UE 115 may support both TDD and FDD operation in conjunction with carrier aggregation such that, for example, the UE 115 communicates in accordance with an FDD communication scheme via a first carrier and in accordance with a TDD communication scheme via a second carrier. For example, the UE 115 may support the operation illustrated by the RFFE 200 using the second carrier and may support the operation illustrated by the RFFE 201 using the first carrier. In some implementations, the UE 115 may coordinate with a network entity 105 regarding any interruptions of downlink signaling to the UE 115, including interruptions associated with (due to or caused by) a temporary switch, at the UE 115, from the first carrier (the FDD carrier) to the second carrier (the TDD carrier).

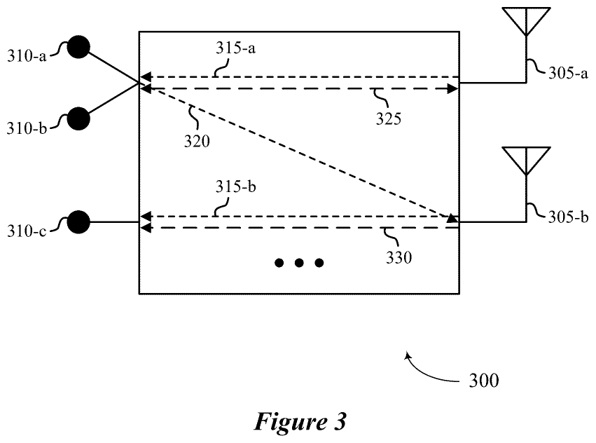

FIG. 3 shows example Tx/Rx paths at an RFFE 300 that supports coordination of a downlink interruption associated with an uplink transmission switch from an FDD carrier to a TDD carrier in accordance with one or more aspects of the present disclosure. The RFFE 300 may implement or be implemented to realize or facilitate one or more aspects of the wireless communication system 100. For example, a UE 115 (or any other wireless communication device illustrated by or described with reference to FIG. 1) may support (such as use, operate, or configure) the RFFE 300.

The RFFE 300 may include a set of antennas, a set of RF chains, and Tx/Rx paths (such as signal paths) between the set of antennas and the set of RF chains. As illustrated in the example of FIG. 3, the set of antennas may include an antenna 305-a and an antenna 305-b, although a wireless communication device may operate any quantity of antennas without exceeding the scope of the present disclosure. As also illustrated in the example of FIG. 3, the set of RF chains may include an RF chain 310-a, an RF chain 310-b, and an RF chain 310-c, although a wireless communication device may operate any quantity of RF chains without exceeding the scope of the present disclosure. The RF chain 310-a may be representative of a TDD TRx0 (a first TDD TRx chain) and/or an FDD Rx0 (a first FDD Rx chain). The RF chain 310-b may be representative of an FDD TRx0 (a first FDD TRx chain) and/or a TDD Rx0 (a first TDD Rx chain). The RF chain 310-c may be representative of a TDD Rx1 (a second TDD Rx chain) and/or an FDD Rx1 (a second FDD Rx chain).

In examples in which a UE 115 supports TDD and FDD in a carrier aggregation deployment scenario, which may be understood as TDD+FDD uplink carrier aggregation (ULCA), the UE 115 may use different communication schemes for communication via different carriers. For example, the UE 115 may communicate via a first carrier (such as a first frequency band) using an FDD communication scheme and may communicate via a second carrier (such as a second frequency band) using a TDD communication scheme. Such operation at the UE 115 may be understood as or otherwise associated with a TDD+FDD band combination in carrier aggregation. In the example of the RFFE 300, the UE 115 may support TDD downlink reception via a signal path 315-a and a signal path 315-b, TDD uplink transmission via a signal path 320, FDD uplink transmission and/or downlink reception via a signal path 325, and FDD downlink reception via a signal path 330.

In some scenarios, TDD operation at the UE 115 may be allowed to reprogram an RFFE switch from a first antenna to a second antenna (such as from the antenna 305-a to the antenna 305-b). In other words, the UE 115 may perform an RFFE switch, which may be a temporary switch, to switch TDD communication from the antenna 305-a to the antenna 305-b. The UE 115 may perform such an RFFE switch to switch between uplink and downlink for the second carrier (the TDD carrier). In scenarios in which the UE 115 toggles the RFFE switch between uplink and downlink for the second carrier, the UE 115 may use the same switch for an FDD RF chain (such as for the FDD Rx1 represented by the RF chain 310-c). The UE 115 may lose the FDD Rx1 in scenarios in which TDD programs the RFFE switch, with this loss of the FDD Rx1 lingering (such as lasting or persisting) until there is a switch back (which could be an indefinite amount of time).

Such issues associated with losing one or more FDD RF chains because of a TDD programmed or initiated RFFE switch may become increasingly costly as a quantity of TDD uplink paths (such as signal paths or layers) increases. Additionally, in some systems, the same or similar issues may arise in scenarios in which there is an uplink Tx chain switching between a TDD carrier and any other carrier and in which there is at least one mid-band FDD carrier in the band combination. For example, the same or similar issues may arise in any combination of n41/n40/n38 and n25/n2/n66 carrier aggregation band combinations, including an n41+n25/n66 carrier aggregation band combination. In accordance with losing one or more FDD RF chains in association with performing a switch at the UE 115 from an FDD carrier to a TDD carrier, among other examples, the UE 115 may potentially miss some downlink signaling from a network entity 105, which may adversely impact communication reliability at the UE 115.

To mitigate such issues, the UE 115 may coordinate with a network entity 105 regarding any interruptions of downlink signaling to the UE 115, including interruptions associated with (due to or caused by) a temporary switch, at the UE 115, from an FDD carrier to a TDD carrier. In some implementations, the UE 115 may transmit control signaling to the network entity 105 to convey information associated with any interruptions of downlink signaling to the UE 115. For example, the UE 115 may transmit control signaling that includes or otherwise conveys a first indication of an interruption of downlink signaling to the UE 115 via an FDD carrier and a second indication of a duration of the interruption of the downlink signaling to the UE 115 via the FDD carrier. In some aspects, the UE 115 may include the first and second indications within an information element, such as a same (single) information element.

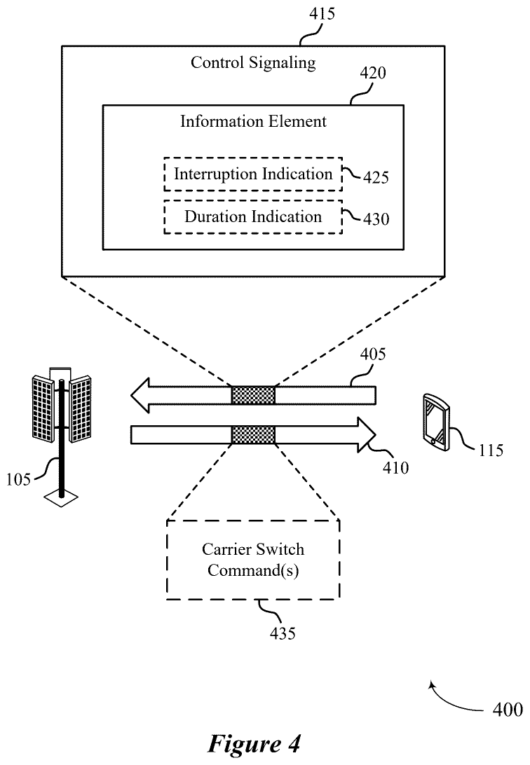

FIG. 4 shows example network signaling 400 that supports coordination of a downlink interruption associated with an uplink transmission switch from an FDD carrier to a TDD carrier in accordance with one or more aspects of the present disclosure. The network signaling 400 may implement or be implemented to realize one or more aspects of the wireless communication system 100, the RFFE 200, the RFFE 201, and/or the RFFE 300. For example, the network signaling 400 illustrates communication between a UE 115 and a network entity 105, which may be examples of corresponding devices as illustrated and/or described with reference to FIGS. 1-3. As illustrated in the example of the network signaling 400, the UE 115 may transmit uplink signaling to the network entity 105 via a communication link 405 and may receive downlink signaling from the network entity 105 via a communication link 410.

In some implementations, the UE 115 and the network entity 105 may support or leverage one or more aspects of the network signaling 400 to support mitigation of interruptions of downlink signaling, such as interruptions of downlink signaling associated with (due to or caused by) a temporary switch, at the UE 115, from a first carrier associated with an FDD communication scheme to a second carrier associated with a TDD communication scheme. For example, in accordance with the network signaling 400, the UE 115 may transmit, to the network entity 105, control signaling 415 (such as RRC signaling, one or more MAC control elements (MAC-CEs), and/or one or more downlink control information (DCI) formats) that includes an information element 420. The information element 420 may be an uplinkTxSwitching-DL-Interruption information element or a variant of the uplinkTxSwitching-DL-Interruption information element, such as an extended uplinkTxSwitching-DL-Interruption information element.

The information element 420 may include a first indication 425 of an interruption of downlink signaling from the network entity 105 to the UE 115 via the first carrier associated with the FDD communication scheme. Additionally, or alternatively, the information element 420 may include a second indication 430 of a duration of the interruption of the downlink signaling from the network entity 105 to the UE 115. For example, the information element 420 may include two fields, elements, or parameters, with a first of the two fields, elements, or parameters including or otherwise providing the first indication 425 and with a second of the two fields, elements, or parameters including or otherwise providing the second indication 430.

In other words, the UE 115 may use the information element 420 to notify the network entity 105 that an FDD downlink interruption will or may occur and, in some aspects, to notify the network entity 105 of which one or more durations within which the FDD downlink interruption will or may occur. For example, the UE 115 may indicate, via the information element 420, that there may be an interruption of downlink signaling within a first duration within which the UE 115 switches a Tx chain from the first carrier (associated with the FDD communication scheme) to the second carrier (associated with the TDD communication scheme), a second duration within which the UE 115 transmits uplink signaling via the communication link 405 in accordance with switching the Tx chain from the first carrier to the second carrier, and a third duration within which the UE 115 switches the Tx chain from the second carrier to the first carrier. In some examples, the first duration and the third duration may each be approximately 140 microseconds. In some examples, the second duration may be a quantity of one or more FDD downlink slots or symbols.

The second indication 430 of the duration of the interruption of the downlink signaling may indicate one or more of the first duration, the second duration, and the third duration individually and/or may indicate two or more of the first duration, the second duration, and the third duration collectively. The second indication 430 of the duration of the interruption of the downlink signaling may indicate one or more of the first duration, the second duration, and the third duration, with a remainder of the first duration, the second duration, and the third duration indicated by other (additional) signaling or defined by a network specification. The second indication 430 of the duration of the interruption of the downlink signaling may indicate a quantity of symbols, a quantity of slots, or any other quantity of time domain units (such as microseconds or milliseconds, among other examples). In some examples, the indicated duration of the interruption of the downlink signaling may be associated with a numerology of the first carrier (the FDD carrier via which the interruption occurs).

In association with transmitting the control signaling 415 to the network entity 105 notifying the network entity 105 of the (anticipated, predicted, expected, scheduled, or planned) interruption of the downlink signaling, the UE 115 may monitor for one or more carrier switch commands 435 from the network entity 105. For example, the network entity 105 may receive the control signaling 415 and transmit (in advance of the interruption) downlink signaling to the UE 115 indicating at what time(s) the UE 115 may perform the switch from the first carrier to the second carrier and/or the switch from the second carrier to the first carrier. The one or more carrier switch commands 435 may include one or more MAC-CEs and/or one or more DCI formats.

In some examples, the one or more carrier switch commands 435 may include a ‘switch-to’ command (indicating the UE 115 to switch from the first carrier to the second carrier at a first time) and a ‘switch-back’ command (indicating the UE 115 to switch from the second carrier to the first carrier at a second time). In such examples, the UE 115 may perform both switches as instructed by the network entity 105. In some other examples, the one or more carrier switch commands 435 may include a ‘switch-to’ command (indicating the UE 115 to switch from the first carrier to the second carrier at a first time) and may exclude a ‘switch-back’ command. In such examples, the UE 115 may perform the switch from the first carrier to the second carrier as instructed by the network entity 105 and may perform a switch from the second carrier to the first carrier on its own (such as in accordance with an autonomous decision or selection at the UE 115).

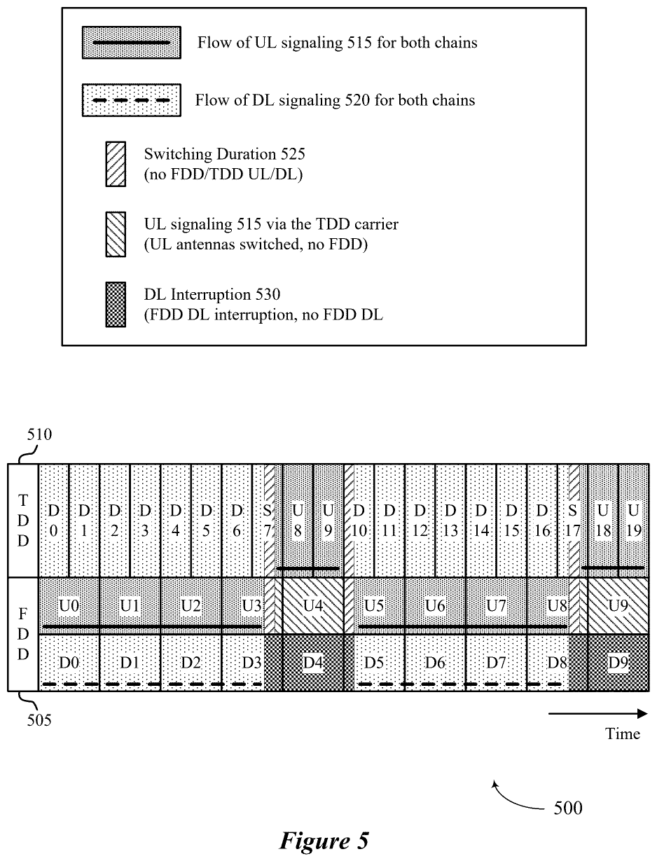

FIG. 5 shows an example communication timeline 500 that supports coordination of a downlink interruption associated with an uplink transmission switch from an FDD carrier to a TDD carrier in accordance with one or more aspects of the present disclosure. The communication timeline 500 may implement or be implemented to realize one or more aspects of the wireless communication system 100, the RFFE 200, the RFFE 201, the RFFE 300, and/or the network signaling 400. For example, the communication timeline 500 illustrates communication between a UE 115 and a network entity 105 via a first carrier 505 associated with an FDD communication scheme and a second carrier 510 associated with a TDD communication scheme, with the UE 115 and the network entity 105 being examples of corresponding devices as illustrated and/or described with reference to FIGS. 1-4.

In accordance with the communication timeline 500, the UE 115 may transmit uplink signaling 515 (denoted in FIG. 5 as “UL signaling”) to the network entity 105 and/or may receive downlink signaling 520 (denoted in FIG. 5 as “DL signaling”) from the network entity 105. The communication timeline 500 may illustrate example time slots within which the UE 115 and the network entity 105 may communicate. For example, the communication timeline 500 illustrates downlink slots (denoted in FIG. 5 as “D” slots) and uplink slots (denoted in FIG. 5 as “U” slots). The communication timeline 500 also illustrates switching slots (denoted in FIG. 5 as “S” slots) within which the UE 115 may perform a switch (of an RF chain at the UE 115) from the first carrier 505 to the second carrier 510 and/or from the second carrier 510 to the first carrier 505. For example, a switching slot may include a switching duration 525, which may be a duration within which the UE 115 performs an RF chain switch between the first carrier 505 and the second carrier 510. Switching slots may include, in addition to a switching duration 525, uplink and/or downlink signaling between the UE 115 and the network entity 105. The first carrier 505 and the second carrier 510 may be associated with different subcarrier spacings (SCSs) and/or different numerologies, such that slot durations may be different across the first carrier 505 and the second carrier 510.

In some examples, the UE 115 may support at least two RF chains, with at least a first RF chain associated with (such as supporting) communication in accordance with the FDD communication scheme via the first carrier 505 and at least a second RF chain associated with (such as supporting) communication in accordance with the TDD communication scheme via the second carrier 510. The UE 115 may support a flow of the uplink signaling 515 for both RF chains throughout the communication timeline 500. At some times, such as times outside of an interruption 530 of downlink signaling 520 (denoted as a “DL interruption” in FIG. 5) from the network entity 105 to the UE 115, the UE 115 may support a flow of the downlink signaling 520 for both RF chains.

In some scenarios, such as in accordance with a satisfaction of a condition or criterion at the UE 115, the UE 115 may determine to switch the first RF chain associated with the communication via the first carrier 505 (associated with the FDD communication scheme) to the second carrier 510 (associated with the TDD communication scheme). Such a switching may result in the interruption 530 of downlink signaling 520 from the network entity 105 to the UE 115 via the first carrier 505, as the UE 115 may instead use the first RF chain and/or an associated antenna of the UE 115 to transmit uplink signaling 515 via the second carrier 510. In such scenarios, the UE 115 may transmit the control signaling 415 to the network entity 105 that includes the information element 420, with the information element 420 including the first indication 425 of the interruption 530 of the downlink signaling 520 and the second indication 430 of a duration of the interruption 530 of the downlink signaling 520. The UE 115 may transmit the control signaling 415 to notify the network entity 105 of the interruption 530 caused by the carrier switching at the UE 115.

In some examples, the UE 115 may account for differences in numerology across the first carrier 505 and the second carrier 510 as part of indicating a duration of the interruption 530. In such examples, the indicated duration of the interruption 530 may be associated with a difference or ratio between a first numerology associated with the first carrier 505 and a second numerology associated with the second carrier 510. In examples in which the UE 115 indicates the duration of the interruption 530 in terms of slots and/or symbols, the UE 115 may indicate the duration of the interruption 530 in a time domain of the first carrier 505 (in accordance with the first numerology) or in a time domain of the second carrier 510 (in accordance with the second numerology). In some examples, the indicated duration of the interruption 530 may be associated with a payload size of the uplink signaling 515 to be transmitted within the interruption 530 and/or a slot format associated with the first carrier 505 and/or the second carrier 510.

The interruption 530 of the downlink signaling 520 from the network entity 105 to the UE 115 via the first carrier 505 may include multiple switching durations 525 (such as a first switching duration 525 within which the UE 115 switches the first RF chain from the first carrier 505 to the second carrier 510 and a second switching duration 525 within which the UE 115 switches the first RF chain from the second carrier 510 back to the first carrier 505). In the example of the communication timeline 500, two switching durations 525 may occur within FDD slots, such as within two FDD symbols in FDD slot #3 and two FDD symbols within FDD slot #5. The interruption 530 of the downlink signaling 520 from the network entity 105 to the UE 115 via the first carrier 505 may additionally include a duration within which the UE 115 transmits uplink signaling 515 via the second carrier 510 (using the first RF chain or using both the first RF chain and the second RF chain). In the example of the communication timeline 500, the duration within which the UE 115 transmits uplink signaling 515 via the second carrier 510 using at least the first RF chain may include a last few (such as a last one, two, or three, among other examples) symbols within the FDD slot #3, all symbols within FDD slot #4, and an initial few (such as an initial one, two, or three, among other examples) symbols within the FDD slot #5.

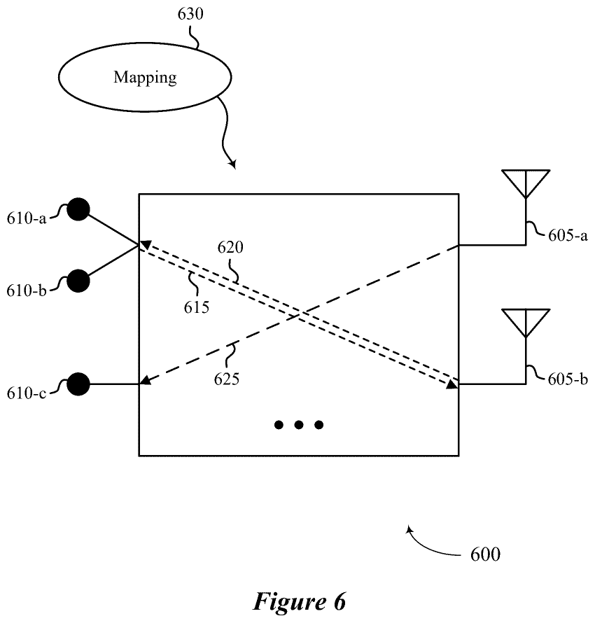

FIG. 6 shows an example signal path grouping 600 that supports coordination of a downlink interruption associated with an uplink transmission switch from an FDD carrier to a TDD carrier in accordance with one or more aspects of the present disclosure. The signal path grouping 600 may implement or be implemented to realize one or more aspects of the wireless communication system 100, the RFFE 200, the RFFE 201, the RFFE 300, the network signaling 400 and/or the communication timeline 500. For example, the signal path grouping 600 illustrates a mechanism according to which a UE 115, which may be an example of a corresponding device as illustrated by and/or described with reference to FIGS. 1-5, mitigates an interruption 530 to downlink signaling 520 by connecting transmit and receive operations (such as by connecting a Tx chain and an Rx chain) together.

An RFFE of the UE 115 may include a set of antennas, a set of RF chains, and Tx/Rx paths (such as signal paths) between the set of antennas and the set of RF chains. As illustrated in the example of FIG. 6, the set of antennas may include an antenna 605-a and an antenna 605-b, although the UE 115 may operate any quantity of antennas without exceeding the scope of the present disclosure. As also illustrated in the example of FIG. 6, the set of RF chains may include an RF chain 610-a, an RF chain 610-b, and an RF chain 610-c, although the UE 115 may operate any quantity of RF chains without exceeding the scope of the present disclosure. The RF chain 610-a may be representative of a TDD TRx0 (a first TDD TRx chain) and/or an FDD Rx0 (a first FDD Rx chain). The RF chain 610-b may be representative of an FDD TRx0 (a first FDD TRx chain) and/or a TDD Rx0 (a first TDD Rx chain). The RF chain 610-c may be representative of a TDD Rx1 (a second TDD Rx chain) and/or an FDD Rx1 (a second FDD Rx chain).

In the example of the signal path grouping 600, the UE 115 may support (such as operate, use, or configure) at least one Tx chain and at least two Rx chains across multiple carriers (such as across the first carrier 505 associated with the FDD communication scheme and the second carrier 510 associated with the TDD communication scheme) on a same antenna of the UE 115. In such examples, the UE 115 may leverage the signal path grouping 600 such that the UE 115 may avoid reprogramming the RFFE of the UE 115 for TDD at times at which the UE 115 transitions between uplink and downlink slots. In other words, in accordance with the signal path grouping 600, TDD operation at the UE 115 may not be expected to or may not have to reprogram the RFFE switches at the UE 115 between uplink and downlink slots.

For example, in accordance with the signal path grouping 600, the UE 115 may use a mapping 630 to connect TDD Tx0 (which may be associated with a signal path 615) and TDD Rx0 (which may be associated with a signal path 620) together to the antenna 605-b. Additionally, the UE 115 may use the mapping 630 to connect TDD Rx1 and FDD Rx1 (both of which may be associated with a signal path 625) to the antenna 605-a. In such implementations, the signal path 625 may co-exist with the signal path 615 and the signal path 620, as the signal paths may avoid sharing any input/output port connections in accordance with the mapping 630. In some examples, the UE 115 may maintain the mapping 630 in scenarios in which the UE 115 performs signal path switches (such as RFFE switches), such that if the UE 115 performs a first signal path switch, the UE 115 may perform a second signal path switch in accordance with the first signal path switch and the mapping 630 to maintain an operational state or mode in which the TDD operation at the UE 115 may not be expected to or may not have to reprogram the RFFE switches at the UE 115 between uplink and downlink slots. In accordance with the signal path grouping 600, the UE 115 may achieve a sufficient throughput without downlink interruption by communicating multiple (such as both) carriers/bands via a same antenna and a same RFFE device.

By implementing the signal path grouping 600 and the mapping 630, the UE 115 may avoid reprogramming RFFE switches, which may support or facilitate reduced hardware, software, and/or firmware complexity at the UE 115 in accordance with the UE 115 avoiding performing (or performing fewer) signal path switches between RF chain(s) and antenna(s) of the UE 115. In accordance with such reduced hardware, software, and/or firmware complexity, the UE 115 may additionally experience reduced power consumption, longer battery life, and greater user experience resulting from more efficient utilization of processing resources, among other benefits. Further, by coordinating and/or managing an RF antenna switch programming in accordance with the signal path grouping 600, the UE 115 may use both FDD Tx and TDD Tx and may still be able to use one or more downlink chains without interruption, which may result in higher data rates, greater throughput, and greater communication reliability. Additionally, by avoiding downlink interruptions due to an RF switch at the UE 115, relatively more carrier/band combinations may be usable (including mid-band and high-band combinations), which may further support higher data rates, greater throughput, and greater communication reliability along with greater system flexibility.

In some implementations, the UE 115 may support the network signaling 400 or the signal path grouping 600 in accordance with whether one or more conditions are satisfied. For example, in scenarios in which the UE 115 supports less than a threshold quantity of antennas, the UE 115 may determine to support the network signaling 400 and may coordinate with the network entity 105 regarding an interruption 530 of downlink signaling 520 from the network entity 105 to the UE 115 via the first carrier 505. Alternatively, in scenarios in which the UE 115 supports at least the threshold quantity of antennas, the UE 115 may support the signal path grouping 600 and avoid an interruption 530 of downlink signaling 520 from the network entity 105 to the UE 115 via the first carrier 505 by implementing and maintaining the mapping 630. In such examples, the threshold quantity of antennas may be a lower limit quantity of antennas sufficient to support the signal path grouping 600.

Additionally, or alternatively, a satisfaction of the one or more conditions may relate to whether an uplink throughput gain associated with the temporary switch from the first carrier 505 to the second carrier 510 satisfies a threshold uplink throughput gain. In such examples, the UE 115 may support the network signaling 400 in scenarios in which the uplink throughput gain satisfies (is at least equal to) the threshold uplink throughput gain. Otherwise, the UE 115 may refrain from performing the temporary switch and/or may support the signal path grouping 600.

Additionally, or alternatively, a satisfaction of the one or more conditions may relate to whether a (predicted or known) downlink throughput loss associated with the temporary switch from the first carrier 505 to the second carrier 510 satisfies a threshold downlink throughput loss. In such examples, the UE 115 may support the network signaling 400 in scenarios in which the downlink throughput loss satisfies (is less than) the threshold downlink throughput loss. Otherwise, the UE 115 may refrain from performing the temporary switch and/or may support the signal path grouping 600. In other words, the UE 115 may support the network signaling 400 in association with determining that an uplink throughput gain achieved by performing the temporary switch outweighs a downlink throughput loss (such that the downlink throughput loss, if any, is tolerable at least in accordance with the uplink throughput gain achieved).

Additionally, or alternatively, a satisfaction of the one or more conditions may relate to whether a priority level of the uplink signaling 515 (for which the UE 115 performs the temporary switch to transmit) satisfies a threshold priority level. In such examples, the UE 115 may support the network signaling 400 in scenarios in which the priority level satisfies (is at least equal to) the threshold priority level. Otherwise, the UE 115 may refrain from performing the temporary switch and/or may support the signal path grouping 600.

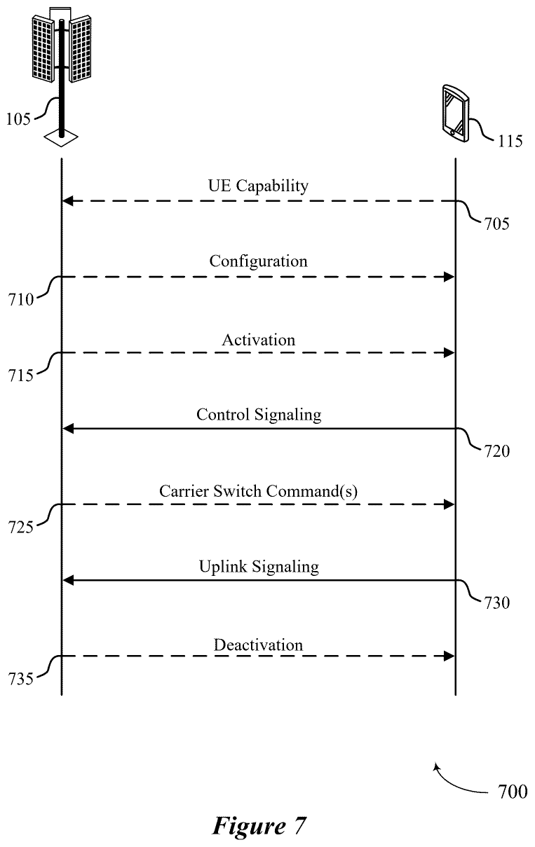

FIG. 7 shows an example process flow 700 that supports coordination of a downlink interruption associated with an uplink transmission switch from an FDD carrier to a TDD carrier in accordance with one or more aspects of the present disclosure. The process flow 700 may implement or be implemented to realize one or more aspects of the wireless communication system 100, the RFFE 200, the RFFE 201, the RFFE 300, the network signaling 400, the communication timeline 500, and/or the signal path grouping 600. For example, the process flow 700 illustrates communication between a UE 115 and a network entity 105, which may be examples of corresponding devices as illustrated and/or described with reference to FIGS. 1-6.

Alternative examples of the following may be implemented. Some steps are performed in a different order than described or are not performed at all. In some implementations, steps may include additional features not mentioned below, or further steps may be added. Further, although example devices are shown performing the operations of the process flow 700, some aspects of some operations also may be performed by one or more other wireless communication devices without exceeding the scope of the present disclosure.

At 705, the UE 115 may transmit information indicative of a UE capability to the network entity 105. For example, the UE 115 may indicate, to the network entity 105, a capability of the UE 115 to support one or more of the network signaling 400, the communication timeline 500, the signal path grouping 600, among other example aspects of the present disclosure. In some implementations, the UE 115 may indicate a capability of the UE 115 to support a temporary switch from the first carrier 505 associated with the FDD communication scheme to the second carrier 510 associated with the TDD communication scheme. The UE 115 may transmit the information indicative of the UE capability via RRC signaling, one or more MAC-CEs, and/or one or more uplink control information (UCI) messages.

At 710, the UE 115 may receive configuration (such as RRC) signaling from the network entity 105. The configuration signaling may indicate one or more parameters associated with the network signaling 400, the communication timeline 500, and/or the signal path grouping 600. Such parameters may indicate one or more lower limit and/or upper limit durations associated with a temporary carrier switch at the UE 115 and/or the mapping 630, among other examples. In some aspects, the configuration signaling from the network entity 105 may be associated with (such as configure or indicate) an establishment of a carrier aggregation at the UE 115 (such as an establishment of a carrier aggregation between the UE 115 and the network entity 105). The carrier aggregation may be associated with multiple carriers including the first carrier 505 and the second carrier 510.

At 715, the UE 115 may receive activation signaling from the network entity 105. The activation signaling may activate one or more operational states or modes at the UE 115, such as an operational state or mode according to which the UE 115 may perform a temporary carrier switch or an operational state or mode according to which TDD operation at the UE 115 may not be expected to or may not have to reprogram RFFE switches at the UE 115 between uplink and downlink slots. The UE 115 may receive the activation signaling from the network entity 105 via RRC signaling, one or more MAC-CEs, and/or one or more DCI formats.

At 720, the UE 115 may transmit control signaling to the network entity 105. The control signaling that the UE 115 transmits at 720 may be an example of the control signaling 415 as illustrated by and described with reference to FIG. 4. For example, the control signaling may include an information element, and the information element may include a first indication of an interruption of downlink signaling from the network entity 105 to the UE 115 via the first carrier 505 associated with the FDD communication scheme and a second indication of a duration of the interruption of the downlink signaling. The information element may provide or include the first indication via or within a first parameter or field of the information element and may provide or include the second indication via or within a second parameter or field of the information element. For example, a first set of one or more parameters or fields of the information element may convey the first indication, and a second set of one or more parameters or fields of the information element may convey the second indication. The interruption of the downlink signaling may be associated with a temporary switch, at the UE 115, from the first carrier 505 associated with the FDD communication scheme to the second carrier 510 associated with the TDD communication scheme. In some examples, the UE 115 may additionally indicate, via the information element, a (requested, scheduled, planned, expected, or anticipated) start time for the temporary switch at the UE 115.

At 725, the UE 115 may receive one or more carrier switch commands from the network entity 105. The one or more carrier switch commands that the UE 115 receives at 725 may be an example of the one or more carrier switch commands 435 as illustrated by and described with reference to FIG. 4. In some examples, the one or more carrier switch commands may include a single command indicating a time at which the UE 115 is to switch from the first carrier 505 to the second carrier 510. In some other examples, the one or more carrier switch commands may include a first command indicating a first time at which the UE 115 is to switch from the first carrier 505 to the second carrier 510 and a second command indicating a second time at which the UE 115 is to switch from the second carrier 510 to the first carrier 505. In some examples, the UE 115 may receive the one or more carrier switch commands from the network entity 105 at least a threshold time duration prior to a start of the carrier switch. For example, the UE 115 may expect to receive the one or more carrier switch commands at least one slot prior to the start of the carrier switch (such that if the carrier switch is planned to start within an FDD slot #3, the UE 115 may expect to receive the one or more carrier switch commands within an FDDL slot #2, if not earlier).

At 730, the UE 115 may transmit uplink signaling to the network entity 105 via the second carrier 510 within the duration of the interruption of the downlink signaling. In examples in which the UE 115 switches a first RF chain from the first carrier 505 to the second carrier 510, the UE 115 may use at least the first RF chain to transmit the uplink signaling via the second carrier 510. The uplink signaling may include control signaling and/or data signaling. For example, the uplink signaling may include one or more physical uplink control channel (PUCCH) transmissions and/or one or more physical uplink shared channel (PUSCH) transmissions.

At 735, the UE 115 may receive deactivation signaling from the network entity 105. The deactivation signaling may deactivate one or more operational states or modes at the UE 115, such as an operational state or mode according to which the UE 115 may perform a temporary carrier switch or an operational state or mode according to which TDD operation at the UE 115 may not be expected to or may not have to reprogram RFFE switches at the UE 115 between uplink and downlink slots. The UE 115 may receive the deactivation signaling from the network entity 105 via RRC signaling, one or more MAC-CEs, and/or one or more DCI formats.

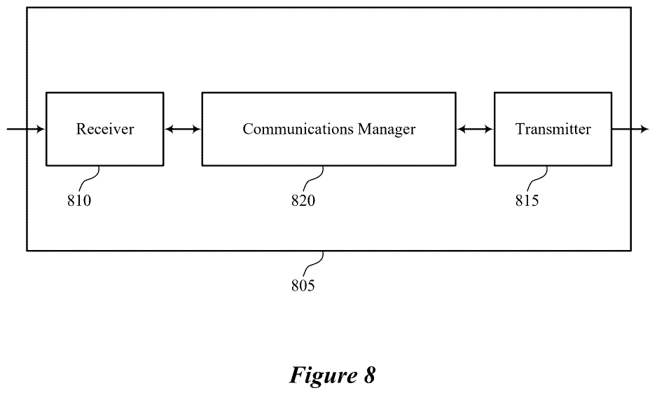

FIG. 8 shows a block diagram of a device 805 that supports coordination of a downlink interruption associated with an uplink transmission switch from an FDD carrier to a TDD carrier in accordance with one or more aspects of the present disclosure. The device 805 may be an example of aspects of a UE 115. The device 805 may include a receiver 810, a transmitter 815, and a communications manager 820. The device 805, or one or more components of the device 805 (such as the receiver 810, the transmitter 815, the communications manager 820), may include at least one processor, which may be coupled with at least one memory, to, individually or collectively, support or enable the described techniques. Each of these components may be in communication with one another (such as via one or more buses).

The receiver 810 may provide a means for receiving information such as packets, user data, control information, or any combination thereof associated with various information channels (such as control channels, data channels, information channels related to coordination of a downlink interruption associated with an uplink transmission switch from a frequency division duplexing carrier to a time division duplexing carrier). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (such as control channels, data channels, information channels related to coordination of a downlink interruption associated with an uplink transmission switch from a frequency division duplexing carrier to a time division duplexing carrier). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of coordination of a downlink interruption associated with an uplink transmission switch from an FDD carrier to a TDD carrier. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (such as in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 820, the receiver 810, the transmitter 815, or various combinations or components thereof may be implemented in code (such as communications management software or firmware) executed by at least one processor (such as referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 820 may be configured to perform various operations (such as receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations.

The communications manager 820 may support wireless communication in accordance with examples as disclosed herein. For example, the communications manager 820 is capable of, configured to, or operable to support a means for transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme. The communications manager 820 is capable of, configured to, or operable to support a means for transmitting uplink signaling to the network entity via the second carrier associated with the TDD communication scheme within the duration of the interruption of the downlink signaling.

By including or configuring the communications manager 820, the device 805 (such as at least one processor controlling or otherwise coupled with the receiver 810, the transmitter 815, the communications manager 820, or a combination thereof) may support techniques for more efficient utilization of communication resources.

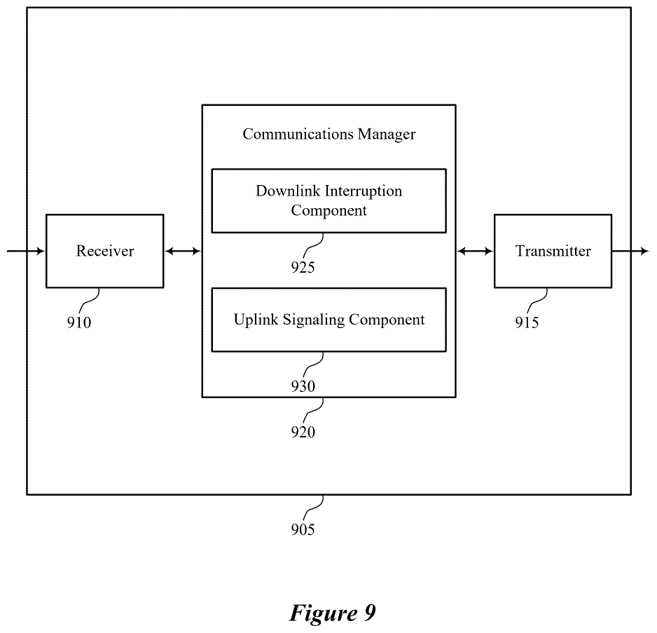

FIG. 9 shows a block diagram of a device 905 that supports coordination of a downlink interruption associated with an uplink transmission switch from an FDD carrier to a TDD carrier in accordance with one or more aspects of the present disclosure. The device 905 may be an example of aspects of a device 805 or a UE 115. The device 905 may include a receiver 910, a transmitter 915, and a communications manager 920. The device 905, or one or more components of the device 905 (such as the receiver 910, the transmitter 915, the communications manager 920), may include at least one processor, which may be coupled with at least one memory, to support the described techniques. Each of these components may be in communication with one another (such as via one or more buses).

The receiver 910 may provide a means for receiving information such as packets, user data, control information, or any combination thereof associated with various information channels (such as control channels, data channels, information channels related to coordination of a downlink interruption associated with an uplink transmission switch from a frequency division duplexing carrier to a time division duplexing carrier). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (such as control channels, data channels, information channels related to coordination of a downlink interruption associated with an uplink transmission switch from a frequency division duplexing carrier to a time division duplexing carrier). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of coordination of a downlink interruption associated with an uplink transmission switch from an FDD carrier to a TDD carrier. For example, the communications manager 920 may include a downlink interruption component 925 an uplink signaling component 930, or any combination thereof. The communications manager 920 may be an example of aspects of a communications manager 820. In some examples, the communications manager 920, or various components thereof, may be configured to perform various operations (such as receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations.

The communications manager 920 may support wireless communication in accordance with examples as disclosed herein. The downlink interruption component 925 is capable of, configured to, or operable to support a means for transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme. The uplink signaling component 930 is capable of, configured to, or operable to support a means for transmitting uplink signaling to the network entity via the second carrier associated with the TDD communication scheme within the duration of the interruption of the downlink signaling.

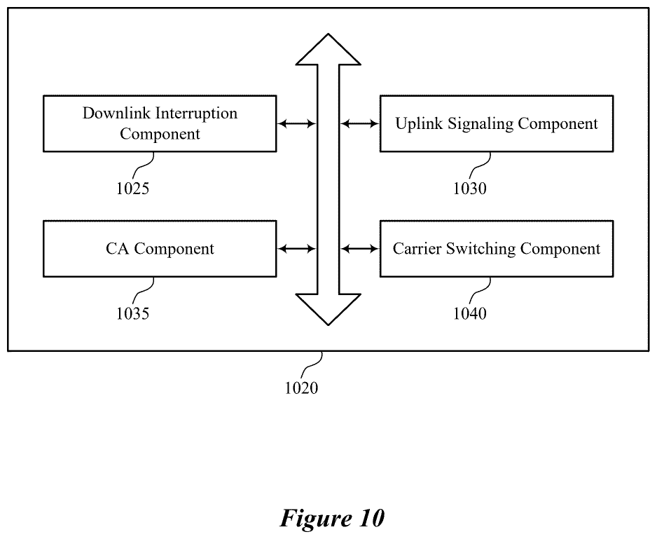

FIG. 10 shows a block diagram of a communications manager 1020 that supports coordination of a downlink interruption associated with an uplink transmission switch from an FDD carrier to a TDD carrier in accordance with one or more aspects of the present disclosure. The communications manager 1020, or various components thereof, may be an example of means for performing various aspects of coordination of a downlink interruption associated with an uplink transmission switch from an FDD carrier to a TDD carrier. For example, the communications manager 1020 may include a downlink interruption component 1025, an uplink signaling component 1030, a CA component 1035, a carrier switching component 1040, or any combination thereof. Each of these components, or components or subcomponents thereof (such as one or more processors, one or more memories), may communicate, directly or indirectly, with one another (such as via one or more buses).

The communications manager 1020 may support wireless communication in accordance with examples as disclosed herein. The downlink interruption component 1025 is capable of, configured to, or operable to support a means for transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme. The uplink signaling component 1030 is capable of, configured to, or operable to support a means for transmitting uplink signaling to the network entity via the second carrier associated with the TDD communication scheme within the duration of the interruption of the downlink signaling.

In some examples, the CA component 1035 is capable of, configured to, or operable to support a means for establishing, in accordance with a carrier aggregation at the UE, a set of multiple carriers associated with communication between the UE and the network entity, the set of multiple carriers including the first carrier associated with the FDD communication scheme and the second carrier associated with the TDD communication scheme.

In some examples, the carrier switching component 1040 is capable of, configured to, or operable to support a means for receiving, from the network entity, a first command that indicates the UE to switch, at a first time, from the first carrier associated with the FDD communication scheme to the second carrier associated with the TDD communication scheme. In some examples, the carrier switching component 1040 is capable of, configured to, or operable to support a means for receiving, from the network entity, a second command that indicates the UE to switch, at a second time, from the second carrier associated with the TDD communication scheme to the first carrier associated with the FDD communication scheme. In some examples, the duration of the interruption of the downlink signaling spans between the first time and the second time.

In some examples, the carrier switching component 1040 is capable of, configured to, or operable to support a means for switching, in association with receiving the first command, a transmit chain of the UE from the first carrier associated with the FDD communication scheme to the second carrier associated with the TDD communication scheme at the first time. In some examples, the carrier switching component 1040 is capable of, configured to, or operable to support a means for switching, in association with receiving the second command, the transmit chain of the UE from the second carrier associated with the TDD communication scheme to the first carrier associated with the FDD communication scheme at the second time.

In some examples, receiving the first command or the second command, or both, is in association with transmitting the control signaling that includes the information element.

In some examples, the carrier switching component 1040 is capable of, configured to, or operable to support a means for receiving, from the network entity, a command that indicates the UE to switch, at a first time, from the first carrier associated with the FDD communication scheme to the second carrier associated with the TDD communication scheme. In some examples, the duration of the interruption of the downlink signaling spans from the first time.

In some examples, the carrier switching component 1040 is capable of, configured to, or operable to support a means for switching, in association with receiving the command, a transmit chain of the UE from the first carrier associated with the FDD communication scheme to the second carrier associated with the TDD communication scheme at the first time. In some examples, the carrier switching component 1040 is capable of, configured to, or operable to support a means for switching, in association with an autonomous decision at the UE, the transmit chain of the UE from the second carrier associated with the TDD communication scheme to the first carrier associated with the FDD communication scheme at a second time. In some examples, the second time is equal to the first time plus the duration of the interruption of the downlink signaling.

In some examples, receiving the command is in association with transmitting the control signaling that includes the information element.

In some examples, the duration of the interruption of the downlink signaling includes a first duration within which a transmit chain of the UE switches from the first carrier associated with the FDD communication scheme to the second carrier associated with the TDD communication scheme; a second duration within which the UE transmits the uplink signaling via the second carrier associated with the TDD communication scheme; and a third duration within which the transmit chain of the UE switches from the second carrier associated with the TDD communication scheme to the first carrier associated with the FDD communication scheme.

In some examples, the UE includes a set of multiple transmit chains. In some examples, the set of multiple transmit chains includes a first transmit chain initially associated with the first carrier associated with the FDD communication scheme and a second transmit chain initially associated with the second carrier associated with the TDD communication scheme. In some examples, the UE switches the first transmit chain from the first carrier associated with the FDD communication scheme to the second carrier associated with the TDD communication scheme in accordance with the temporary switch from the first carrier associated with the FDD communication scheme to the second carrier associated with the TDD communication scheme and transmits the uplink signaling using at least the first transmit chain.

In some examples, the duration of the interruption of the downlink signaling is associated with a payload size of the uplink signaling or a slot format associated with the second carrier associated with the TDD communication scheme, or both.

In some examples, the duration of the interruption of the downlink signaling includes a quantity of symbols or a quantity of slots, or any combination thereof. In some examples, the duration of the interruption of the downlink signaling is associated with a numerology of the first carrier associated with the FDD communication scheme.

In some examples, the UE transmits the control signaling that includes the information element in accordance with a satisfaction of a condition at the UE. In some examples, the satisfaction of the condition at the UE includes an uplink throughput gain associated with the temporary switch satisfying a threshold uplink throughput gain; a predicted downlink throughput loss associated with the temporary switch satisfying a threshold downlink throughput loss; or a priority level of the uplink signaling satisfying a threshold priority level.

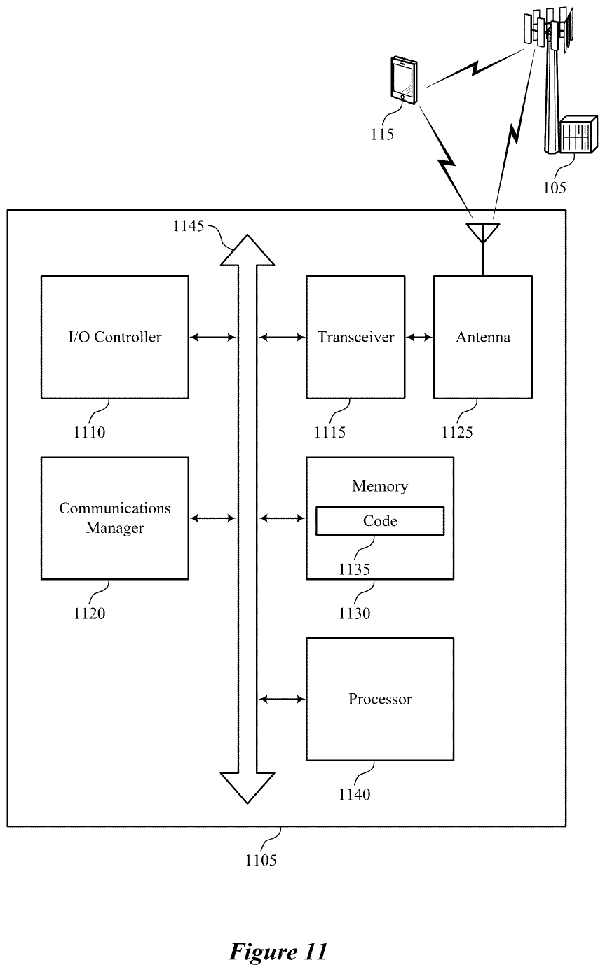

FIG. 11 shows a diagram of a system including a device 1105 that supports coordination of a downlink interruption associated with an uplink transmission switch from an FDD carrier to a TDD carrier in accordance with one or more aspects of the present disclosure. The device 1105 may be an example of or include components of a device 805, a device 905, or a UE 115. The device 1105 may communicate (such as wirelessly) with one or more other devices (such as network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (such as operatively, communicatively, functionally, electronically, electrically) via one or more buses (such as a bus 1145).

The I/O controller 1110 may manage input and output signals for the device 1105. The I/O controller 1110 also may manage peripherals not integrated into the device 1105. In some examples, the I/O controller 1110 may represent a physical connection or port to an external peripheral. In some examples, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some examples, the I/O controller 1110 may be implemented as part of one or more processors, such as the at least one processor 1140. In some examples, a user may interact with the device 1105 via the I/O controller 1110 or via hardware components controlled by the I/O controller 1110.

In some examples, the device 1105 may include a single antenna. However, in some other examples, the device 1105 may have more than one antenna, which may be capable of concurrently transmitting or receiving multiple wireless transmissions. The transceiver 1115 may communicate bi-directionally via the one or more antennas 1125 using wired or wireless links. For example, the transceiver 1115 may represent a wireless transceiver and may communicate bi-directionally with another wireless transceiver. The transceiver 1115 also may include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some examples, the code 1135 may not be directly executable by the at least one processor 1140 but may cause a computer (such as when compiled and executed) to perform functions described herein. In some examples, the at least one memory 1130 may include, among other things, a basic I/O system (BIOS) which may control basic hardware or software operation such as the interaction with peripheral components or devices.

The at least one processor 1140 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some examples, the at least one processor 1140 may be configured to operate a memory array using a memory controller. In some other examples, a memory controller may be integrated into the at least one processor 1140. The at least one processor 1140 may be configured to execute computer-readable instructions stored in a memory (such as the at least one memory 1130) to cause the device 1105 to perform various functions (such as functions or tasks supporting coordination of a downlink interruption associated with an uplink transmission switch from a frequency division duplexing carrier to a time division duplexing carrier). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, being “configured to,” being “configurable to,” and being “operable to” may be used interchangeably and may be associated with a capability, when executing code 1135 (such as processor-executable code) stored in the at least one memory 1130 or otherwise, to perform one or more of the functions described herein.

The communications manager 1120 may support wireless communication in accordance with examples as disclosed herein. For example, the communications manager 1120 is capable of, configured to, or operable to support a means for transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme. The communications manager 1120 is capable of, configured to, or operable to support a means for transmitting uplink signaling to the network entity via the second carrier associated with the TDD communication scheme within the duration of the interruption of the downlink signaling.

By including or configuring the communications manager 1120, the device 1105 may support techniques for improved communication reliability, reduced latency, more efficient utilization of communication resources, improved coordination between devices, and improved utilization of processing capability.

In some examples, the communications manager 1120 may be configured to perform various operations (such as receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of coordination of a downlink interruption associated with an uplink transmission switch from an FDD carrier to a TDD carrier, or the at least one processor 1140 and the at least one memory 1130 may be otherwise configured to, individually or collectively, perform or support such operations.

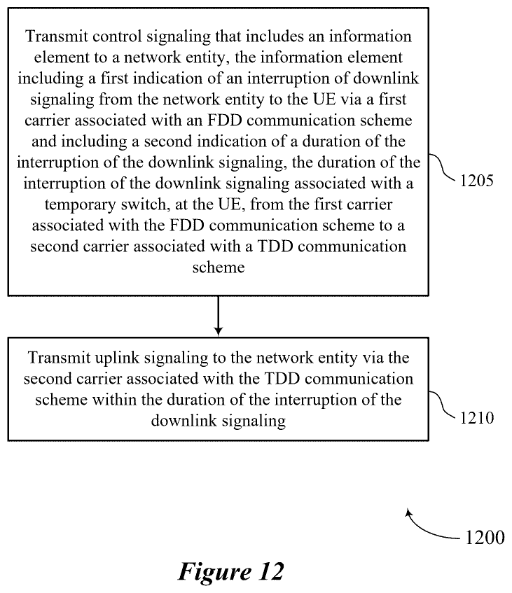

FIG. 12 shows a flowchart illustrating a method 1200 that supports coordination of a downlink interruption associated with an uplink transmission switch from an FDD carrier to a TDD carrier in accordance with one or more aspects of the present disclosure. The operations of the method 1200 may be implemented by a UE or its components. For example, the operations of the method 1200 may be performed by a UE 115 as described with reference to FIGS. 1-11. In some examples, a UE may execute a set of instructions to control the functional elements of the UE to perform the described functions. Additionally, or alternatively, the UE may perform aspects of the described functions using special-purpose hardware.

At 1205, the method may include transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme. The operations of 1205 may be performed in accordance with examples as disclosed herein. In some examples, aspects of the operations of 1205 may be performed by a downlink interruption component 1025 as described with reference to FIG. 10.

At 1210, the method may include transmitting uplink signaling to the network entity via the second carrier associated with the TDD communication scheme within the duration of the interruption of the downlink signaling. The operations of 1210 may be performed in accordance with examples as disclosed herein. In some examples, aspects of the operations of 1210 may be performed by an uplink signaling component 1030 as described with reference to FIG. 10.

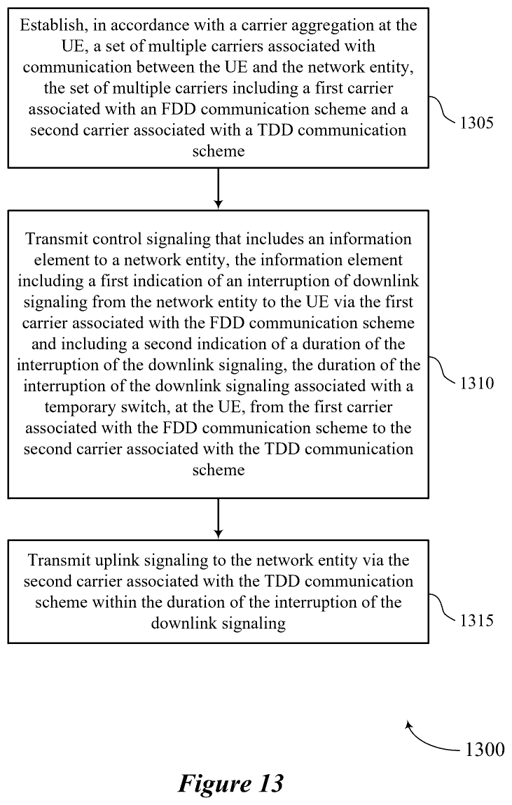

FIG. 13 shows a flowchart illustrating a method 1300 that supports coordination of a downlink interruption associated with an uplink transmission switch from an FDD carrier to a TDD carrier in accordance with one or more aspects of the present disclosure. The operations of the method 1300 may be implemented by a UE or its components. For example, the operations of the method 1300 may be performed by a UE 115 as described with reference to FIGS. 1-11. In some examples, a UE may execute a set of instructions to control the functional elements of the UE to perform the described functions. Additionally, or alternatively, the UE may perform aspects of the described functions using special-purpose hardware.

At 1305, the method may include establishing, in accordance with a carrier aggregation at the UE, a set of multiple carriers associated with communication between the UE and the network entity, the set of multiple carriers including a first carrier associated with an FDD communication scheme and a second carrier associated with a TDD communication scheme. The operations of 1305 may be performed in accordance with examples as disclosed herein. In some examples, aspects of the operations of 1305 may be performed by a CA component 1035 as described with reference to FIG. 10.

At 1310, the method may include transmitting control signaling that includes an information element to a network entity, the information element including a first indication of an interruption of downlink signaling from the network entity to the UE via the first carrier associated with the FDD communication scheme and including a second indication of a duration of the interruption of the downlink signaling, the duration of the interruption of the downlink signaling associated with a temporary switch, at the UE, from the first carrier associated with the FDD communication scheme to the second carrier associated with the TDD communication scheme. The operations of 1310 may be performed in accordance with examples as disclosed herein. In some examples, aspects of the operations of 1310 may be performed by a downlink interruption component 1025 as described with reference to FIG. 10.

At 1315, the method may include transmitting uplink signaling to the network entity via the second carrier associated with the TDD communication scheme within the duration of the interruption of the downlink signaling. The operations of 1315 may be performed in accordance with examples as disclosed herein. In some examples, aspects of the operations of 1315 may be performed by an uplink signaling component 1030 as described with reference to FIG. 10.

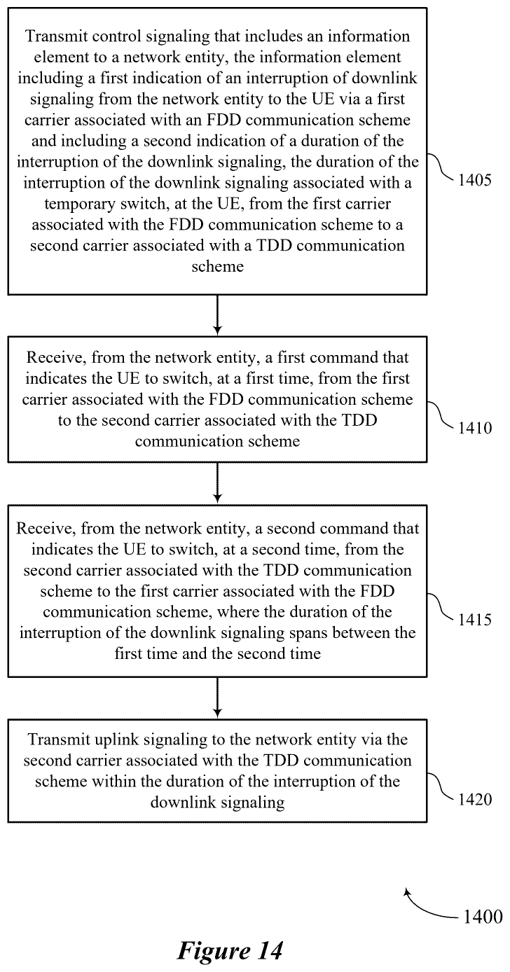

FIG. 14 shows a flowchart illustrating a method 1400 that supports coordination of a downlink interruption associated with an uplink transmission switch from an FDD carrier to a TDD carrier in accordance with one or more aspects of the present disclosure. The operations of the method 1400 may be implemented by a UE or its components. For example, the operations of the method 1400 may be performed by a UE 115 as described with reference to FIGS. 1-11. In some examples, a UE may execute a set of instructions to control the functional elements of the UE to perform the described functions. Additionally, or alternatively, the UE may perform aspects of the described functions using special-purpose hardware.

At 1405, the method may include transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme. The operations of 1405 may be performed in accordance with examples as disclosed herein. In some examples, aspects of the operations of 1405 may be performed by a downlink interruption component 1025 as described with reference to FIG. 10.

At 1410, the method may include receiving, from the network entity, a first command that indicates the UE to switch, at a first time, from the first carrier associated with the FDD communication scheme to the second carrier associated with the TDD communication scheme. The operations of 1410 may be performed in accordance with examples as disclosed herein. In some examples, aspects of the operations of 1410 may be performed by a carrier switching component 1040 as described with reference to FIG. 10.

At 1415, the method may include receiving, from the network entity, a second command that indicates the UE to switch, at a second time, from the second carrier associated with the TDD communication scheme to the first carrier associated with the FDD communication scheme, where the duration of the interruption of the downlink signaling spans between the first time and the second time. The operations of 1415 may be performed in accordance with examples as disclosed herein. In some examples, aspects of the operations of 1415 may be performed by a carrier switching component 1040 as described with reference to FIG. 10.

At 1420, the method may include transmitting uplink signaling to the network entity via the second carrier associated with the TDD communication scheme within the duration of the interruption of the downlink signaling. The operations of 1420 may be performed in accordance with examples as disclosed herein. In some examples, aspects of the operations of 1420 may be performed by an uplink signaling component 1030 as described with reference to FIG. 10.

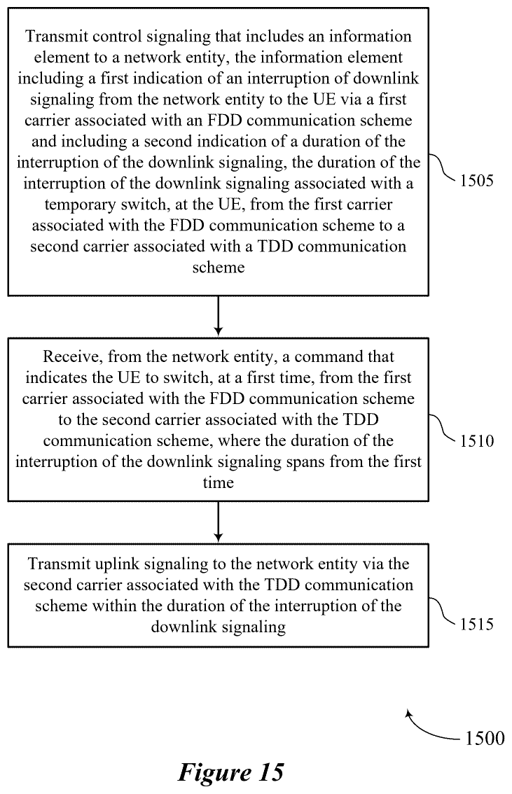

FIG. 15 shows a flowchart illustrating a method 1500 that supports coordination of a downlink interruption associated with an uplink transmission switch from an FDD carrier to a TDD carrier in accordance with one or more aspects of the present disclosure. The operations of the method 1500 may be implemented by a UE or its components. For example, the operations of the method 1500 may be performed by a UE 115 as described with reference to FIGS. 1-11. In some examples, a UE may execute a set of instructions to control the functional elements of the UE to perform the described functions. Additionally, or alternatively, the UE may perform aspects of the described functions using special-purpose hardware.

At 1505, the method may include transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme. The operations of 1505 may be performed in accordance with examples as disclosed herein. In some examples, aspects of the operations of 1505 may be performed by a downlink interruption component 1025 as described with reference to FIG. 10.

At 1510, the method may include receiving, from the network entity, a command that indicates the UE to switch, at a first time, from the first carrier associated with the FDD communication scheme to the second carrier associated with the TDD communication scheme, where the duration of the interruption of the downlink signaling spans from the first time. The operations of 1510 may be performed in accordance with examples as disclosed herein. In some examples, aspects of the operations of 1510 may be performed by a carrier switching component 1040 as described with reference to FIG. 10.

At 1515, the method may include transmitting uplink signaling to the network entity via the second carrier associated with the TDD communication scheme within the duration of the interruption of the downlink signaling. The operations of 1515 may be performed in accordance with examples as disclosed herein. In some examples, aspects of the operations of 1515 may be performed by an uplink signaling component 1030 as described with reference to FIG. 10.

The following provides an overview of aspects of the present disclosure:
Aspect 1: A method for wireless communication at a UE, including: transmitting control signaling that includes an information element to a network entity, the information element including a first indication of an interruption of downlink signaling from the network entity to the UE via a first carrier associated with an FDD communication scheme and including a second indication of a duration of the interruption of the downlink signaling, the duration of the interruption of the downlink signaling associated with a temporary switch, at the UE, from the first carrier associated with the FDD communication scheme to a second carrier associated with a TDD communication scheme; and transmitting uplink signaling to the network entity via the second carrier associated with the TDD communication scheme within the duration of the interruption of the downlink signaling.
Aspect 2: The method of aspect 1, further including: establishing, in accordance with a carrier aggregation at the UE, a plurality of carriers associated with communication between the UE and the network entity, the plurality of carriers including the first carrier associated with the FDD communication scheme and the second carrier associated with the TDD communication scheme.
Aspect 3: The method of any of aspects 1-2, further including: receiving, from the network entity, a first command that indicates the UE to switch, at a first time, from the first carrier associated with the FDD communication scheme to the second carrier associated with the TDD communication scheme; and receiving, from the network entity, a second command that indicates the UE to switch, at a second time, from the second carrier associated with the TDD communication scheme to the first carrier associated with the FDD communication scheme, where the duration of the interruption of the downlink signaling spans between the first time and the second time.
Aspect 4: The method of aspect 3, further including: switching, in association with receiving the first command, a transmit chain of the UE from the first carrier associated with the FDD communication scheme to the second carrier associated with the TDD communication scheme at the first time; and switching, in association with receiving the second command, the transmit chain of the UE from the second carrier associated with the TDD communication scheme to the first carrier associated with the FDD communication scheme at the second time.
Aspect 5: The method of any of aspects 3-4, where receiving the first command or the second command, or both, is in association with transmitting the control signaling that includes the information element.
Aspect 6: The method of any of aspects 1-5, further including: receiving, from the network entity, a command that indicates the UE to switch, at a first time, from the first carrier associated with the FDD communication scheme to the second carrier associated with the TDD communication scheme, where the duration of the interruption of the downlink signaling spans from the first time.
Aspect 7: The method of aspect 6, further including: switching, in association with receiving the command, a transmit chain of the UE from the first carrier associated with the FDD communication scheme to the second carrier associated with the TDD communication scheme at the first time; and switching, in association with an autonomous decision at the UE, the transmit chain of the UE from the second carrier associated with the TDD communication scheme to the first carrier associated with the FDD communication scheme at a second time, where the second time is equal to the first time plus the duration of the interruption of the downlink signaling.
Aspect 8: The method of any of aspects 6-7, where receiving the command is in association with transmitting the control signaling that includes the information element.
Aspect 9: The method of any of aspects 1-8, where the duration of the interruption of the downlink signaling includes a first duration within which a transmit chain of the UE switches from the first carrier associated with the FDD communication scheme to the second carrier associated with the TDD communication scheme; a second duration within which the UE transmits the uplink signaling via the second carrier associated with the TDD communication scheme; and a third duration within which the transmit chain of the UE switches from the second carrier associated with the TDD communication scheme to the first carrier associated with the FDD communication scheme.
Aspect 10: The method of any of aspects 1-9, where the UE includes a plurality of transmit chains, the plurality of transmit chains includes a first transmit chain initially associated with the first carrier associated with the FDD communication scheme and a second transmit chain initially associated with the second carrier associated with the TDD communication scheme, and the UE switches the first transmit chain from the first carrier associated with the FDD communication scheme to the second carrier associated with the TDD communication scheme in accordance with the temporary switch from the first carrier associated with the FDD communication scheme to the second carrier associated with the TDD communication scheme and transmits the uplink signaling using at least the first transmit chain.
Aspect 11: The method of any of aspects 1-10, where the duration of the interruption of the downlink signaling is associated with a payload size of the uplink signaling or a slot format associated with the second carrier associated with the TDD communication scheme, or both.
Aspect 12: The method of any of aspects 1-11, where the duration of the interruption of the downlink signaling includes a quantity of symbols or a quantity of slots, or any combination thereof, and the duration of the interruption of the downlink signaling is associated with a numerology of the first carrier associated with the FDD communication scheme.
Aspect 13: The method of any of aspects 1-12, where the UE transmits the control signaling that includes the information element in accordance with a satisfaction of a condition at the UE, and the satisfaction of the condition at the UE includes an uplink throughput gain associated with the temporary switch satisfying a threshold uplink throughput gain; a predicted downlink throughput loss associated with the temporary switch satisfying a threshold downlink throughput loss; or a priority level of the uplink signaling satisfying a threshold priority level.
Aspect 14: A UE, including a processing system that includes processor circuitry and memory circuitry that stores code, the processing system configured to cause the UE to perform a method of any of aspects 1-13.
Aspect 15: A UE, including one or more memories storing processor-executable code, and one or more processors coupled with the one or more memories and individually or collectively operable to execute the code to cause the UE to perform a method of any of aspects 1-13.
Aspect 16: A UE, including at least one means for performing a method of any of aspects 1-13.
Aspect 17: A non-transitory computer-readable medium storing code for wireless communication, the code including instructions executable by one or more processors (such as a processing system) to perform a method of any of aspects 1-13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor also may be implemented as a combination of computing devices (such as a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions also may be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. In examples in which the software is transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), and/or ascertaining. Also, “determining” can include receiving (such as receiving information) and/or accessing (such as accessing data stored in memory). Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
transmit capability signaling to a network entity, the capability signaling indicating a capability of the UE to support uplink transmission switching between a first carrier via which the UE communicates in accordance with a frequency division duplexing (FDD) communication scheme and a second carrier via which the UE communicates in accordance with a time division duplexing (TDD) communication scheme;
receive configuration signaling that indicates a carrier aggregation between the first carrier and the second carrier in accordance with the capability signaling;
communicate, using at least a first antenna of the UE, with the network entity via the first carrier in accordance with the FDD communication scheme and, using a second antenna of the UE, with the network entity via the second carrier in accordance with the TDD communication scheme;
transmit, using the first antenna of the UE, uplink signaling via the second carrier in accordance with switching both uplink transmission and downlink reception via the second carrier from the second antenna to the first antenna such that a signal path grouping at the UE is maintained; and
receive, using the second antenna of the UE and simultaneously with transmitting the uplink signaling via the second carrier, downlink signaling via the first carrier in accordance with switching the uplink transmission and the downlink reception via the second carrier from the second antenna to the first antenna and in accordance with the signal path grouping at the UE.

2. The UE of claim 1, wherein the signal path grouping comprises connecting the uplink transmission which is associated with one signal path and the downlink reception which is associated with another signal path together to at least one of the first antenna or the second antenna.

3. The UE of claim 1, wherein a downlink throughput loss in accordance with switching the uplink transmission via the second carrier from the second antenna to the first antenna satisfies a threshold downlink throughput loss.

4. The UE of claim 1, further comprising a first transmit chain and a first receive chain that are configured to communicate via the second carrier, wherein:
the signal path grouping comprises a first connection between the first transmit chain and the first receive chain,
the first transmit chain and the first receive chain are connected to the second antenna prior to the switching, and
the first transmit chain and the first receive chain are connected to the first antenna after the switching in accordance with the first connection.

5. The UE of claim 4, further comprising a second receive chain configured to communicate via the first carrier, wherein:
the second receive chain is connected to the first antenna prior to the switching, and
the second receive chain is connected to the second antenna after the switching in accordance with the signal path grouping.

6. The UE of claim 5, further comprising a third receive chain configured to communicate via the second carrier, wherein:
the signal path grouping comprises a second connection between the second receive chain and the third receive chain;
the third receive chain is connected to the first antenna prior to the switching, and
the third receive chain is connected to the second antenna after the switching based at least in part on switching both the second receive chain and the third receive chain to the second antenna in accordance with the second connection.

7. The UE of claim 4, further comprising at least one of a second receive chain or a second transmit chain that is configured to communicate via the first carrier, wherein:
the first connection is between the first transmit chain, the first receive chain, and at least the one of the second receive chain or the second transmit chain,
at least the one of the second receive chain or the second transmit chain is connected to the second antenna prior to the switching, and
at least the one of the second receive chain or the second transmit chain is connected to the first antenna after the switching based at least in part on switching at least the one of the second receive chain or the second transmit chain to the first antenna in accordance with the first connection.

8. The UE of claim 1, wherein the uplink signaling is transmitted over one or more uplink slots, and wherein the processing system is further configured to cause the UE to:
receive, using the first antenna of the UE, second downlink signaling via the second carrier over one or more downlink slots, wherein the UE receives the second downlink signaling without reprogramming a radio frequency front end switch between the one or more uplink slots and the one or more downlink slots.

9. The UE of claim 1, wherein the first carrier comprises a mid-band carrier and the second carrier comprises a high-band carrier.

10. The UE of claim 1, wherein the processing system is further configured to cause the UE to:
transmit, to the network entity and based at least in part on satisfaction of one or more conditions, control signaling that comprises an information element, the information element comprising:
a first indication of an interruption of second downlink signaling from the network entity to the UE via the first carrier, and
a second indication of a duration of the interruption of the second downlink signaling, the duration of the interruption of the second downlink signaling associated with a temporary switch, at the UE, from the first carrier to the second carrier.

11. The UE of claim 10, wherein the one or more conditions comprise an uplink throughput gain associated with the temporary switch satisfying a threshold uplink throughput gain, a downlink throughput loss associated with the temporary switch satisfying a threshold downlink throughout loss, or a priority level of second uplink signaling transmitted by the UE in accordance with the temporary switch satisfying a threshold priority level.

12. A method for wireless communication by a user equipment (UE), comprising:
transmitting capability signaling to a network entity, the capability signaling indicating a capability of the UE to support uplink transmission switching between a first carrier via which the UE communicates in accordance with a frequency division duplexing (FDD) communication scheme and a second carrier via which the UE communicates in accordance with a time division duplexing (TDD) communication scheme;
receiving configuration signaling that indicates a carrier aggregation between the first carrier and the second carrier in accordance with the capability signaling;
communicating, using at least a first antenna of the UE, with the network entity via the first carrier in accordance with the FDD communication scheme and, using a second antenna of the UE, with the network entity via the second carrier in accordance with the TDD communication scheme;
transmitting, using the first antenna of the UE, uplink signaling via the second carrier in accordance with switching both uplink transmission and downlink reception via the second carrier from the second antenna to the first antenna such that a signal path grouping at the UE is maintained; and
receiving, using the second antenna of the UE and simultaneously with transmitting the uplink signaling via the second carrier, downlink signaling via the first carrier in accordance with switching the uplink transmission via the second carrier from the second antenna to the first antenna and in accordance with the signal path grouping at the UE.

13. The method of claim 12, wherein the signal path grouping comprises connecting the uplink transmission which is associated with one signal path and the downlink reception which is associated with another signal path together to at least one of the first antenna or the second antenna.

14. The method of claim 12, wherein a downlink throughput loss in accordance with switching the uplink transmission via the second carrier from the second antenna to the first antenna satisfies a threshold downlink throughput loss.

15. The method of claim 12, wherein:
the signal path grouping comprises a first connection between a first transmit chain and a first receive chain that are configured to communicate via the second carrier,
the first transmit chain and the first receive chain are connected to the second antenna prior to the switching, and
the first transmit chain and the first receive chain are connected to the first antenna after the switching in accordance with the first connection.

16. The method of claim 15, wherein:
a second receive chain configured to communicate via the first carrier is connected to the first antenna prior to the switching, and
the second receive chain is connected to the second antenna after the switching in accordance with the signal path grouping.

17. The method of claim 16, wherein:
the signal path grouping comprises a second connection between the second receive chain and a third receive chain,
the third receive chain configured to communicate via the second carrier is connected to the first antenna prior to the switching, and
the third receive chain is connected to the second antenna after the switching based at least in part on switching both the second receive chain and the third receive chain to the second antenna in accordance with the second connection.

18. The method of claim 15, wherein:
the first connection is between the first transmit chain, the first receive chain, and at least one of a second receive chain or a second transmit chain that is configured to communicate via the first carrier,
at least the one of the second receive chain or the second transmit chain is connected to the second antenna prior to the switching, and
at least the one of the second receive chain or the second transmit chain is connected to the first antenna after the switching based at least in part on switching at least the one of the second receive chain or the second transmit chain to the first antenna in accordance with the signal path grouping.

19. The method of claim 12, wherein the uplink signaling is transmitted over one or more uplink slots, the method further comprising:
receiving, using the first antenna of the UE, second downlink signaling via the second carrier over one or more downlink slots, wherein the UE receives the second downlink signaling without reprogramming a radio frequency front end switch between the one or more uplink slots and the one or more downlink slots.

20. The method of claim 12, wherein the first carrier comprises a mid-band carrier and the second carrier comprises a high-band carrier.
